(19) United States
(12) Patent Application Publication
(10) Pub. No.: US 2016/0216284 A1
(43) Pub. Date: Jul. 28, 2016

(54) CARTRIDGES, ANALYZERS, AND SYSTEMS FOR ANALYZING SAMPLES

(71) Applicant: OPTI Medical Systems, Inc., Westbrook, ME (US)

(72) Inventors: Garland C. Misener, Portland, ME (US); Kevin T. Kirspel, Cumming, GA (US); Vlad Moise, Marietta, GA (US); Yingzi Wu, Johns Creek, GA (US); Thomas C. Paden, Marietta, GA (US); James R. Salter, Marietta, GA (US)

(21) Appl. No.: 15/007,487

(22) Filed: Jan. 27, 2016

Related U.S. Application Data
(60) Provisional application No. 62/108,832, filed on Jan. 28, 2015.

(51) Int. Cl. G01N 35/00; G01N 35/10; G01N 35/04; B01L 3/00

(52) U.S. Cl. CPC G01N 35/00029; B01L 3/502; G01N 35/10; G01N 35/04; B01L 2300/087; B01L 2300/0663; B01L 2300/0645; B01L 2300/123; B01L 2200/025; G01N 2035/00148; G01N 2035/00554; G01N 2035/1051; G01N 2035/0486; G01N 2035/0489

(57) ABSTRACT

A cartridge, analyzer for use therewith, and system including the cartridge and analyzer. The cartridge is configured to receive a biological fluid to be analyzed and includes a plate defining a main channel, a hemolysis chamber, and an oximetry chamber consecutively interconnected with one another. The analyzer is configured to perform analysis of sample disposed within the main channel, hemolyze sample disposed within the hemolysis chamber, and perform oximetry on sample disposed within the oximetry chamber. The cartridge and analyzer may further include alignment and clamping structures for maintain the cartridge in fixed position and alignment during testing or may further include cooperating features for moving the cartridge relative to the analyzer into a testing position or between various different testing positions.

### CROSS-REFERENCE TO RELATED APPLICATIONS

This application claims the benefit of, and priority to, U.S. Provisional Patent Application No. 62/108,832, filed on Jan. 28, 2015, the entire contents of which are hereby incorporated herein by reference.

### BACKGROUND

1. Technical Field

The present disclosure relates to sample analysis and, more particularly, to cartridges, analyzers, and systems for analyzing a biological sample or other sample to detect and/or measure constituents thereof.

2. Background of Related Art

Fluorescence testing and optical absorbance testing are often utilized to detect and/or measure various different analytes within a sample. With respect to testing blood, for example, fluorescence testing may be utilized to detect and measure constituents of blood gas, electrolytes, and/or metabolites within the blood sample. Other methods of detecting and measuring constituents of blood gas, electrolytes, and/or metabolites within a blood sample include potentiometric and/or amperometric testing, e.g., using Ion Selective Electrode's (ISE's). Optical absorbance testing may be utilized to perform oximetry, e.g., to measure concentrations of MetHb, O₂Hb, RHb, tHb, COHb, etc.

In order to detect and/or measure a plurality of analytes and to perform oximetry, various different testing fixtures, e.g., a fluorometer (for fluorescence-based testing) or ionmeter (for ISE-based testing), and a spectrometer, respectively, are required, as are a plurality of different sensors for detecting and/or measuring each of the various analytes sought. As can be appreciated, this presents a challenge in designing apparatus and systems that facilitate performing various different testing on a sample in an efficient and effective manner.

### SUMMARY

To the extent consistent, any of the aspects detailed herein may be used in conjunction with any of the other aspects detailed herein.

In accordance with the present disclosure, sample cartridges, analyzers for use in testing such sample cartridges, and systems incorporating the same are provided.

Cartridges provided in accordance with the present disclosure may include, for example, a plate defining, on a face surface thereof, a main channel, a hemolysis chamber disposed in fluid communication with the main channel and configured to facilitate hemolysis of sample disposed within the hemolysis chamber, an oximetry chamber configured to facilitate oximetry of sample disposed within the oximetry chamber, and an interconnection channel coupling the hemolysis chamber and the oximetry chamber to one another in fluid communication so as to define a sample flow path from the main channel through the hemolysis chamber and the oximetry chamber.

In embodiments, the cartridge further includes a plurality of sensors disposed on a surface thereof. The sensors are positioned adjacent to and in alignment with the main channel defined within the plate. The sensors may be configured as chemical fluorescence sensors, although other suitable sensors are also contemplated, e.g., ISE's. The sensors may be disposed on a flexible membrane of the cartridge, on a rigid surface thereof, or may be otherwise positioned depending, for example, upon the type of sensors utilized.

In embodiments, the cartridge may further include a flexible membrane disposed about and sealed to the face surface of the plate, or a flexible membrane drum disposed adjacent the hemolysis chamber. In either configuration, the drum or portion of the flexible membrane disposed adjacent the hemolysis chamber is configured to transmit ultrasonic energy to sample disposed within the hemolysis chamber, e.g., to hemolyze sample disposed within the hemolysis chamber.

In embodiments where so provided, the flexible membrane is formed from an outer film layer and an inner adhesive layer configured to adhere the flexible membrane to the face surface of the plate. In embodiments, a portion of the inner adhesive layer disposed adjacent the oximetry chamber is removed to define a cut-out. The plate may further define a protrusion that protrudes into the oximetry chamber and opposes the cut-out to define an optical path length between an opposed surface of the protrusion of the plate and an opposed surface of the outer film layer of the flexible membrane, e.g., of between 50 μm and 110 μm, between 70 μm and 90 μm, or of 80 μm.

In embodiments, a suction port is disposed in communication with the sample flow path. The cartridge may further include a socket configured to couple to a sample source while the suction port is configured to couple to a pump for aspirating sample from the sample source into the main channel and for initiating the flow of sample along the sample flow path.

In embodiments, the plate further includes one or more carrier elements disposed along each longitudinal side edge thereof or otherwise positioned relative thereto. The one or more carrier elements are configured to operably engage a carrier assembly to translate the cartridge relative to an analyzer configured to receive the cartridge. The carrier elements may be configured as gear racks extending longitudinally along the longitudinal side edges of the plate and defining a plurality of teeth, may define frictional engagement surfaces, or may define other suitable configurations.

In embodiments, the plate further defines at least one alignment aperture extending therethrough. The at least one alignment aperture is configured to facilitate alignment of the plate within an analyzer.

In embodiments, the plate further defines at least one jog. More specifically, a first jog may be defined within the plate between the main channel and the hemolysis chamber in fluid communication therewith. The first jog is configured to inhibit the transmission of energy, e.g., ultrasonic energy, along the sample flow path upstream from the hemolysis chamber. Additionally or alternatively, a second jog may be defined within the interconnection channel of the plate and positioned between the hemolysis chamber and the oximetry chamber in fluid communication herewith. The second jog is configured to inhibit the transmission of energy, e.g., ultrasonic energy, along the sample flow path downstream from the hemolysis chamber.

A system for testing a sample provided in accordance with the present disclosure includes an analyzer and a cartridge. The analyzer includes one or more detection apparatus, e.g., fluorometers, ionmeters, etc., a hemolyzer, and an oximeter. The cartridge is configured for operable engagement with the analyzer and includes a main channel, a plurality of sensors disposed adjacent the main channel that are configured to facilitate fluorescence detection via the one or more fluorometers (or detection in another suitable fashion using a different apparatus such as ISE's and an ionmeter), a hemolysis chamber disposed in fluid communication with the main channel and configured to hemolyze sample disposed within the hemolysis chamber, and an oximetry chamber disposed in fluid communication with the hemolysis chamber and configured to facilitate oximetry of sample disposed within the oximetry chamber via the oximeter. The cartridge defines a sample flow path from the main channel through the hemolysis chamber and the oximetry chamber for flow of sample therethrough and testing thereof as sample flows through each portion of the cartridge.

In embodiments, the number of fluorometers (or other detection apparatus) in the analyzer is equal to or less than the number of sensors in the cartridge. In embodiments where the number of fluorometers (or other detection apparatus) in the analyzer is equal to the number of sensors in the cartridge, the analyzer may be configured to receive (manually of via an auto-feed mechanism), align, and clamp the cartridge in position for subsequent testing. In embodiments where the number of fluorometers (or other detection apparatus) in the analyzer is less than the number of sensors in the cartridge, the analyzer may be configured to move the cartridge between two or more testing positions for enabling fluorescence detection (or other detection) of each of the sensors and/or for moving the cartridge between two or more testing locations associated with different testing apparatus.

In embodiments, the analyzer includes a carrier assembly configured to move the cartridge between at least two positions. The carrier assembly, more specifically, may be configured to feed the cartridge into a testing position within the analyzer and/or may be configured to move the cartridge between different testing positions within the analyzer.

In embodiments, the cartridge includes a gear rack disposed along each longitudinal side edge thereof and the carrier assembly includes a guide configured to slidably receive at least a portion of the cartridge as well as one or more driven pinion gears disposed adjacent the guide. Each driven pinion gear is configured to operably engage one of the gear racks of the cartridge such that, upon rotational driving of the driven pinion gear, the cartridge is translated relative to the guide. A motor may be provided for driving the driven pinion gear(s). In embodiments, the carrier assembly further includes one or more idler pinion gears configured to operably engage one of the gear racks of the cartridge to guide translation of the cartridge relative to the guide. The carrier assembly may further include an alignment mechanism coupled to each of the idler pinion gears and configured to align the cartridge relative to the guide as the cartridge is translated relative thereto.

In embodiments, the cartridge includes a friction surface extending along each longitudinal side thereof and the carrier assembly includes a guide, a driven roller, and a motor. The guide is configured to slidably receive the cartridge. The driven roller is positioned adjacent the guide and is configured to frictionally engage one of the friction surfaces of the cartridge such that, upon rotational driving of the driven roller, the cartridge is translated relative to the guide. The motor is configured to drive the driven roller. In embodiments, the carrier assembly further includes an idler roller configured to frictionally engage one of the friction surfaces of the cartridge opposite the driven roller to guide translation of the cartridge relative to the guide.

In embodiments, the hemolyzer includes an ultrasonic probe configured to contact a portion of the cartridge adjacent the hemolysis chamber to transmit ultrasonic energy to sample disposed within the hemolysis chamber.

In embodiments, the oximetry chamber defines an optical path length of between 50 μm and 110 μm, between 70 μm and 90 μm, or of 80 μm to facilitate oximetry of sample disposed within the oximetry chamber via the oximeter.

In embodiments, the cartridge further includes a suction port and the analyzer further includes a pump configured to couple to the suction port for aspirating sample into the cartridge and for initiating the flow of sample along the sample flow path. Further, the cartridge may include a socket configured to couple to a sample source from which sample is aspirated into the cartridge.

In embodiments, the analyzer further includes a cartridge-retainer assembly configured to operably retain the cartridge therein. Additionally or alternatively, the analyzer may further include a support assembly that supports the at least one detection apparatus, the hemolyzer, and the oximeter. The analyzer may further include a clamp assembly configured to move the support assembly relative to the cartridge-retainer assembly to clamp the cartridge therebetween.

In embodiments, the analyzer further includes a heater configured to heat the cartridge to a pre-determined temperature and/or maintain the cartridge at a pre-determined temperature.

In embodiments, the cartridge defines at least one alignment aperture and the analyzer includes at least one peg. The at least one peg is configured for receipt within the at least one alignment aperture to align the cartridge relative to the analyzer.

An analyzer provided in accordance with the present disclosure includes a detection block including a plurality of chemical detection apparatus, a hemolyzer, an oximeter, and a cartridge-receiving portion configured to receive and operably position a cartridge relative to the detection block, hemolyzer, and oximeter. The cartridge may be a single-use cartridge.

In embodiments, each chemical detection apparatus includes a fluorometer having an emission assembly and a detection assembly. The emission assemblies of adjacent fluorometers may be positioned on opposite sides of the corresponding detection assemblies thereof. Additionally or alternatively, the detection assembly of each fluorometer may include an emission fiber, an emission filter, and a detector, wherein a conical-shaped aperture is defined between the emission filter and the detector of each detection assembly to inhibit rays of light that are non-perpendicular relative to the emission filter from reaching the detector.

In embodiments, at least one of the chemical detection apparatus includes a voltmeter configured for measuring a voltage from an ion-specific electrode sensor.

In embodiments, the cartridge-receiving portion includes a carrier assembly configured similar to any of the above-detailed embodiments. The carrier assembly of the cartridge-receiving portion of the analyzer may further be configured to automatically feed the cartridge into a testing position within the analyzer and/or to translate the cartridge between different testing positions within the analyzer.

In embodiments, the analyzer is configured to facilitate introduction of a sample into the cartridge once the cartridge is received and operably positioned relative to the detection block, hemolyzer, and oximeter.

The analyzer may otherwise be configured similar to any of the embodiments detailed above.

### BRIEF DESCRIPTION OF THE DRAWINGS

Various aspects of the present disclosure are described herein with reference to the drawings wherein like reference numerals identify similar or identical elements:

FIG. 1 is a top, perspective view of an analyzer provided in accordance with the present disclosure;

FIG. 2 is a rear, perspective view of the analyzer of FIG. 1 with the handle disposed in a carrying position;

FIG. 3 is a top, perspective view of the analyzer of FIG. 1 in an open position exposing the internal assembly thereof;

FIG. 4A is a perspective view of a cartridge provided in accordance with the present disclosure and configured for use with the analyzer of FIG. 1 or any other suitable analyzer;

FIG. 4B is a cross-sectional view of the cartridge of FIG. 4A taken along section line “4B-4B” in FIG. 4A;

FIG. 5 is a perspective view of a fixture block configured for use with the analyzer of FIG. 1 or any other suitable analyzer;

FIG. 6 is a cross-sectional view of an internal assembly configured for use with the analyzer of FIG. 1 or any other suitable analyzer, including the fixture block of FIG. 5 taken along section line “6-6” of FIG. 5 and further including the cartridge of FIG. 4A and a carrier assembly operably positioned relative to the fixture block;

FIG. 7 is a cross-sectional view of the fixture block of FIG. 5 taken along section line “7-7” of FIG. 5 and further including the cartridge and the carrier assembly operably positioned relative to the fixture block;

FIG. 8 is a cross-sectional view of the fixture block of FIG. 5 taken along section line “8-8” of FIG. 5 and further including the cartridge and the carrier assembly operably positioned relative to the fixture block;

FIG. 9A is a bottom, perspective view of the carrier assembly of FIGS. 6 and 7 having the cartridge of FIG. 4A operably coupled with the carrier assembly;

FIG. 9B is a top, perspective view of the carrier assembly of FIGS. 6 and 7 having the cartridge of FIG. 4A operably coupled with the carrier assembly;

FIG. 10 is a top, perspective view of an internal assembly configured for use with the analyzer of FIG. 1 or any other suitable analyzer;

FIG. 11 is a bottom, perspective view of the internal assembly of FIG. 11;

FIG. 12A is a top, perspective view of the cartridge-retainer assembly of the internal assembly of FIGS. 10 and 11;

FIG. 12B is a bottom, perspective view of the cartridge-retainer assembly of FIG. 12A;

FIG. 13 is a bottom, perspective view of one configuration of a cartridge configured for use with the internal assembly of FIG. 10 or any other suitable internal assembly;

FIG. 14 is a bottom, perspective view of another configuration of the cartridge of FIG. 13, configured for use with the internal assembly of FIG. 10 or any other suitable analyzer;

FIG. 15A is a top, perspective view of the internal assembly of FIG. 10 with the cartridge-retainer assembly removed;

FIG. 15B is a bottom, perspective view of the internal assembly of FIG. 10 with the cartridge-retainer assembly removed;

FIG. 16A is a longitudinal, cross-sectional view of the internal assembly of FIG. 10 with the cartridge-retainer assembly removed;

FIG. 16B is a transverse, cross-sectional view of the internal assembly of FIG. 10 with the cartridge-retainer assembly removed and a cartridge operable engaged therewith; and

FIG. 17 is a transverse, cross-sectional view of the internal assembly of FIG. 10 including a cartridge operable engaged therewith.

### DETAILED DESCRIPTION

Provided in accordance with the present disclosure and detailed below are apparatus, e.g., cartridges and analyzers configured for use therewith, and systems that facilitate the detection and/or measurement of a plurality of analytes within a biological sample, e.g., blood, plasma, serum, urine, and/or plural samples, or other suitable sample. More specifically, the present disclosure provides sample analysis systems each including an analyzer containing an internal assembly, and a disposable (single-use) cartridge configured for use with the internal assembly. Although the aspects and features of the present disclosure are detailed below with respect to blood samples to be tested for constituents of blood gas, electrolytes, metabolites, and oximetry metrics, the aspects and features of the present disclosure are equally applicable for use in testing any suitable sample for any suitable analytes, metrics, and/or other variables. Further, although a particular aspect or feature is detailed with respect to one of the systems, analyzers, and/or cartridges of the present disclosure, it is understood that such aspect or feature is equally applicable to any of the other embodiments detailed herein, to the extent consistency allows.

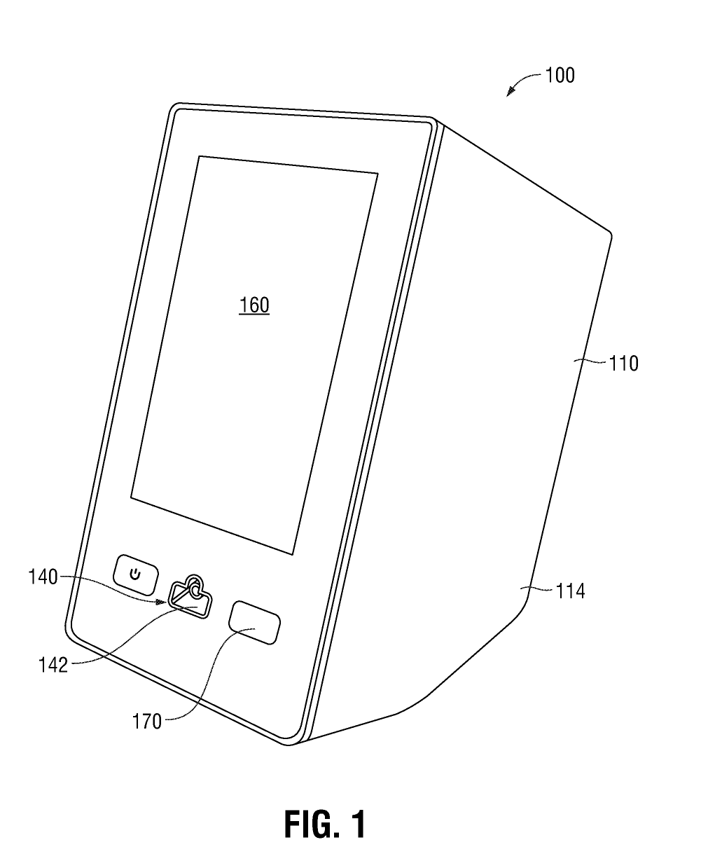

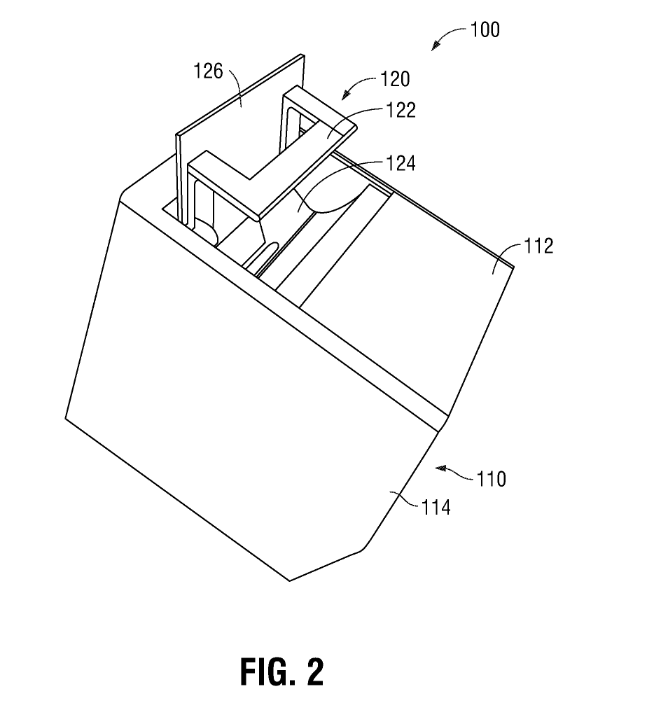

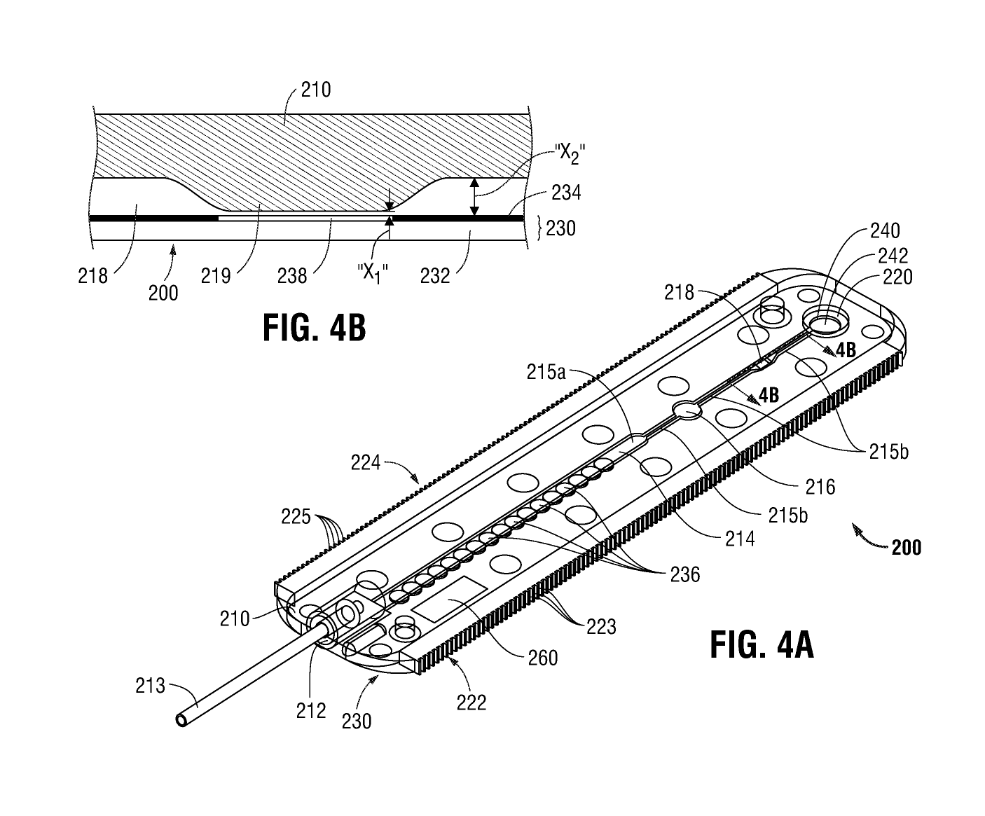

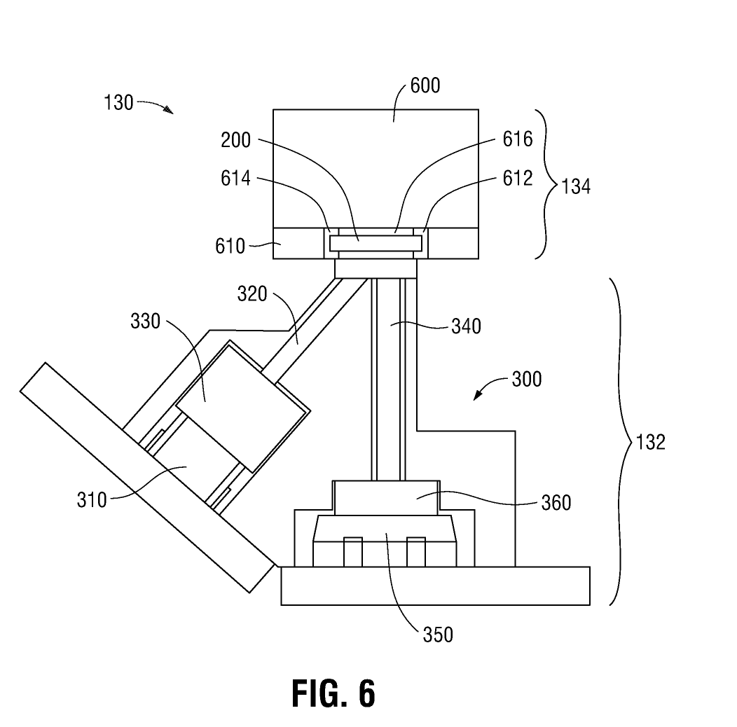

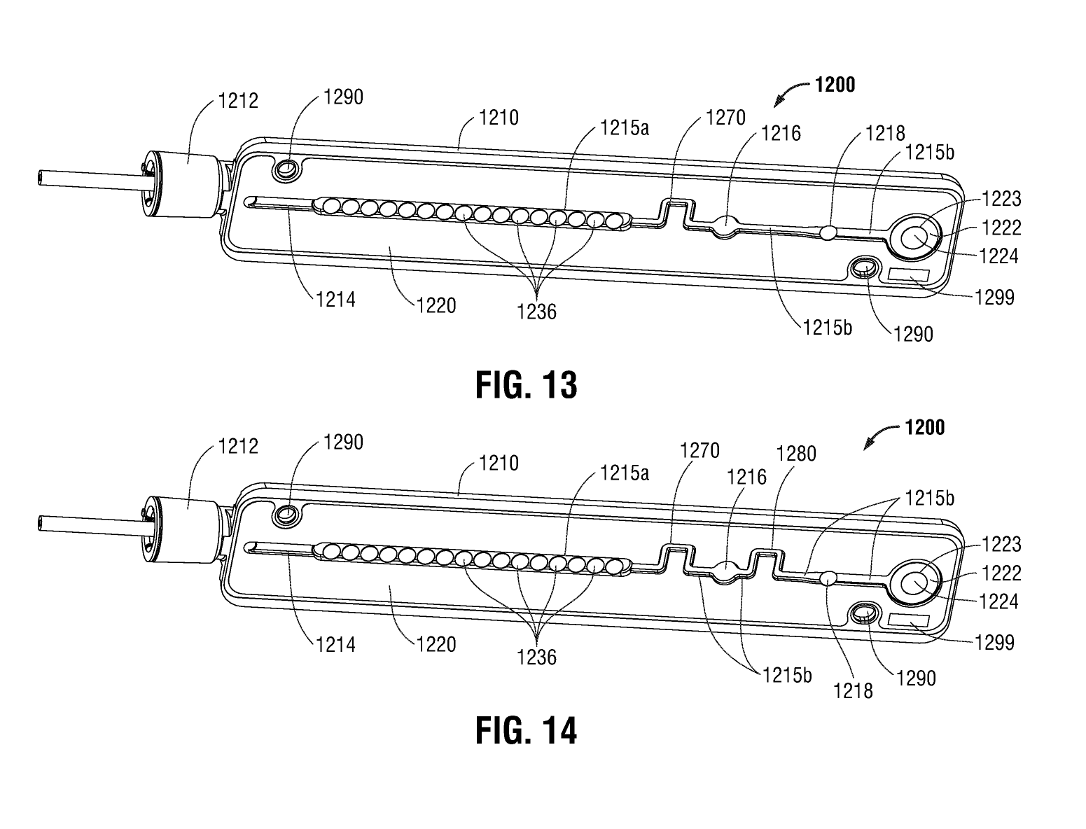

Referring to FIGS. 1-3, a system provided in accordance with embodiments of the present disclosure generally includes an analyzer 100 and a disposable cartridge 200 (FIGS. 4A and 4B), 1200 (FIGS. 13 and 14). Analyzer 100 includes an outer housing 110 that houses the internal components of analyzer 100 and generally includes a printer portion (not shown), a handle assembly 120 (FIG. 2), an internal assembly 130 (FIG. 6), 1020 (FIGS. 1, 10, and 11), a cartridge-receiving portion 140, a touch-screen graphical user interface (“GUI”) 160, a scanner 170 (e.g., a barcode scanner, RFID scanner, or other suitable identification scanner), and control electronics (not shown). Analyzer 100 may further include a battery compartment (not shown) to enable battery-powered use when connection to a standard outlet is not practical, and wired and/or wireless connectivity to enable analyzer 100 to interface with health information systems, laboratory information systems, other devices and/or systems, etc.

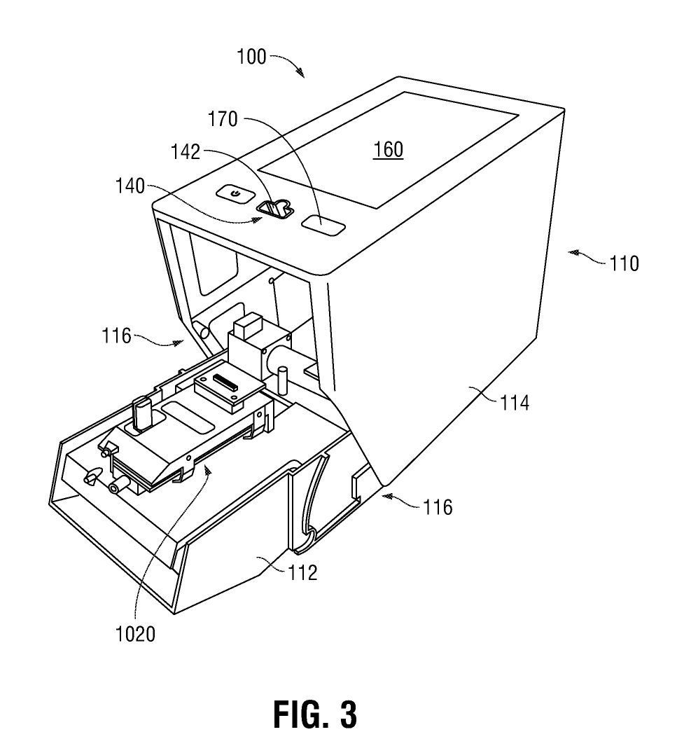

Housing 110 includes a base 112 and a cover 114 that is coupled to base 112 on opposed sides thereof via a hinge and cam mechanism 116 to enable pivoting of cover 114 relative to base 112 between a closed position (FIG. 1) and an open position (FIG. 3) to expose the internal components of analyzer 100 for service, to replace components, upgrade components, and/or add/remove components.

With reference to FIG. 2, handle assembly 120 includes a handle 122, a recess 124, and a door 126. Handle assembly 120 is pivotable relative to housing 110 between a storage position, wherein handle 122 is disposed within recess 124 and door 126 covers recess 124, and a carrying position, wherein door 126 is open and handle 122 extends from recess 124 to facilitate grasping handle 122 for carrying analyzer 100.

The printer portion of analyzer 100 includes a printer (not shown) configured for printing the results of the analysis performed via analyzer 100.

Referring to FIG. 3, base 112 of housing 110 is configured to operably mount an internal assembly 130 (FIG. 6), 1020 (FIGS. 1, 10, and 11) thereon. Analyzer 100 may define a modular configuration such that, for example, internal assembly 130 (FIG. 6) may be removed and replaced with internal assembly 1020 (FIGS. 1, 10, and 11), and vice versa. Other suitable internal assemblies may also be used in conjunction with housing 110. Internal assembly 130 (FIG. 6) includes a fixture block 132 and a carrier assembly 134, each of which will be described in detail below (see FIG. 6). Internal assembly 1020 (FIGS. 1, 10, and 11) and the components thereof are also detailed below.

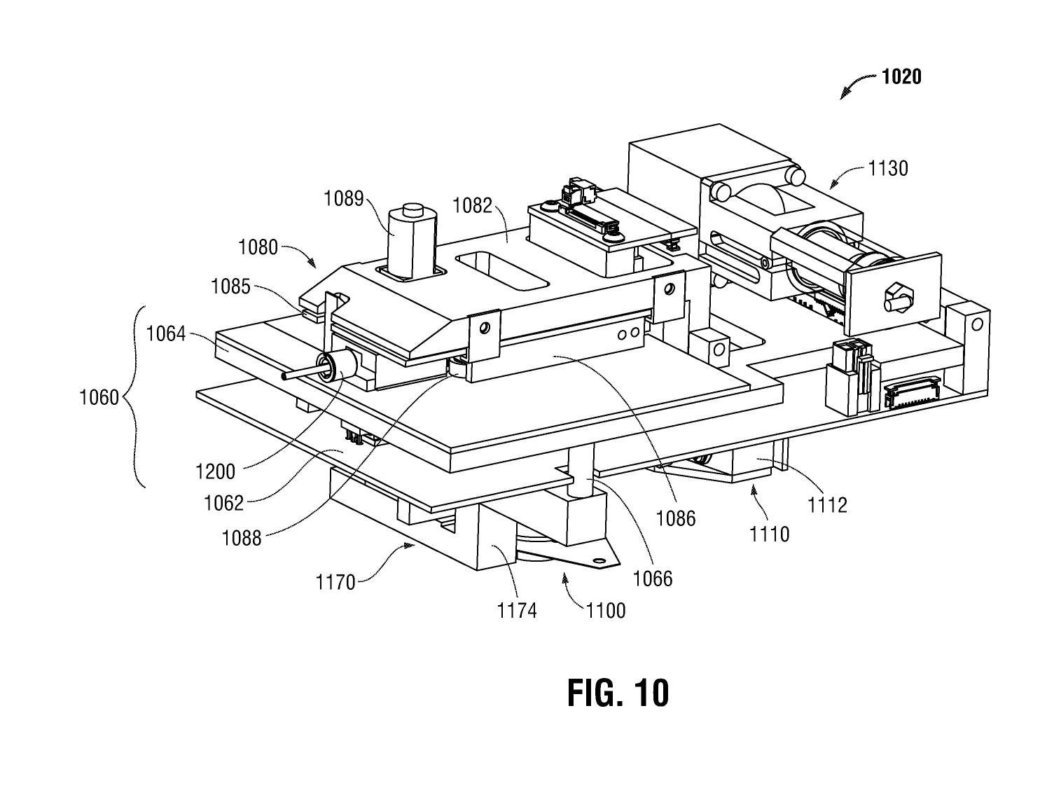

With reference to FIGS. 1 and 2, cartridge-receiving portion 140 of analyzer 100 is configured to receive a cartridge 200 (FIGS. 4A and 4B), 1200 (FIGS. 13 and 14), which is inserted into bay 142 of cartridge-receiving portion 140 and slid into engagement with the internal assembly 130 (FIG. 6), 1020 (FIGS. 1, 10, and 11). In the engaged position, a sampling device (not shown), e.g., syringe, glass capillary, etc., may be coupled to the cartridge 200 (FIGS. 4A and 4B), 1200 (FIGS. 13 and 14) to permit the sample to be aspirated into the cartridge 200 (FIGS. 4A and 4B), 1200 (FIGS. 13 and 14). More specifically, a syringe pump, e.g., syringe pump 1130 (FIG. 10) or other suitable pump, disposed within housing 110 is configured to aspirate the sample from the sampling device (not shown) into the cartridge 200 (FIGS. 4A and 4B), 1200 (FIGS. 13 and 14) and initiate the flow of the sample through the cartridge 200 (FIGS. 4A and 4B), 1200 (FIGS. 13 and 14).

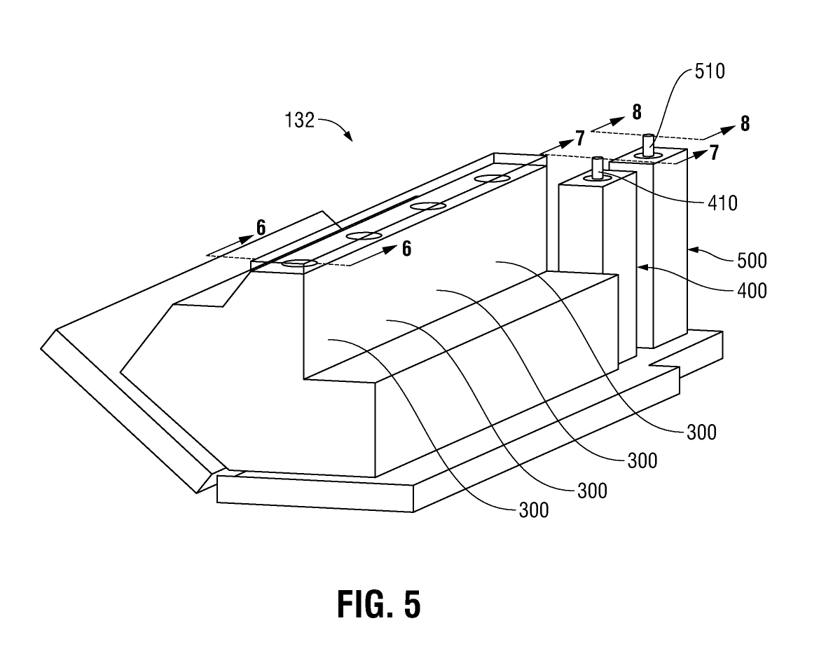

Touch-screen GUI 160 provides a tablet-like interface to enable the user to operate analyzer 100, for example, to input data and/or settings, select parameters and/or options, view the status of a test, view results, print/send results, etc. Scanner 170 is configured to scan the barcode 260, 1299 (or other suitable readable code, e.g., RFID), of the cartridge 200 (FIG. 4), 1200 (FIGS. 13 and 14), respectively, to enable identification and tracking of the cartridge 200, 1200. The control electronics (not shown) of analyzer 100 include hardware and software that operate and control the various operating components of analyzer 100. Embodiments of internal assemblies 130 (FIGS. 5-9B) and 1020 (FIGS. 10-12B and 15-17) configured for use with analyzer 100 are described in greater detail below. Other internal components of analyzer 100 (part of or separate from the internal assembly) not specifically detailed below may include any suitable components for supporting and/or enabling the operation of analyzer 100. In particular, analyzer 100 may include any of the aspects and features of the OPTI LION™ Electrolyte Analyzer, sold by OPTIMedical, which is a company of IDEXX Laboratories, Inc. of Westbrook, Me., USA.

With reference to FIG. 4A, a cartridge 200 for use with internal assembly 130 (FIG. 6) of analyzer 100 (FIG. 1) is configured as a single-use, disposable component. As such, a new cartridge 200 is utilized for each run, or test, through analyzer 100 (FIGS. 1-3) and, at the completion of testing, is discarded. Cartridge 200 includes a plate 210 and, in some embodiments, a flexible membrane 230 (see also FIG. 4B) adhered to plate 210 in sealing engagement. Plate 210 is formed from a suitable plastic (or other suitable material) via injection molding (or other suitable process) and defines a sample socket 212, a main channel 214, an ultrasonic hemolysis chamber 216, an oximetry chamber 218, and a reservoir 220. Plate 210 further defines first and second gear racks 222, 224, respectively, each including a plurality of gear teeth 223, 225, respectively, extending along opposite longitudinal side edges thereof. The above-noted features of plate 210 may be defined within plate 210 during the injection molding process, or may be otherwise formed. Each of the above-noted features of plate 210 is detailed below. Flexible membrane 230, in embodiments where provided, as shown in FIG. 4B, includes a PET film layer 232 and a pressure-sensitive adhesive layer 234 laminated to one another (although other configurations are also contemplated) that, together, enclose and define a sample flow path through main channel 214, ultrasonic hemolysis chamber 216, oximetry chamber 218, and reservoir 220 of plate 210. Pressure-sensitive adhesive layer 234 enables flexible membrane 230 to be adhered to the underside of plate 210 in sealing engagement therewith. Flexible membrane 230 further includes a plurality of sensors 236 (although sensors 236 may be otherwise disposed on and/or coupled to plate 210), a cut-out 238, and a suction port 240, each of which will be detailed below. A barcode 260, or other suitable identifier, is printed, adhered, burned into, or otherwise disposed on cartridge 200, e.g., on the topside of plate 210, to readily enable the positioning of cartridge 200 adjacent scanner 170 of analyzer 100 (FIG. 1) for identifying cartridge 200. Additional barcodes 260 may also be provided at other locations on cartridge 200 for similar or different purposes, as noted below.

Sample socket 212 of plate 210 fluidly communicates with main channel 214 and is configured to receive a tube 213 that is adapted to connect the sampling device (not shown) to cartridge 200 for allowing a sample to be aspirated through tube 213 and sample socket 212 and into main channel 214. Tube 213 may be fixedly secured within sample socket 212 or may be removable therefrom. Alternatively, tube 213 need not be provided and, rather, the sampling device (not shown) may be directly coupled to sample socket 212.

Main channel 214 extends longitudinally along plate 210 and defines a linear body portion 215a and a plurality of interconnection portions 215b. Linear body portion 215a of main channel 214 is disposed in fluid communication with sample socket 212 while interconnection portions 215b serve to fluidly interconnect linear body portion 215a, ultrasonic hemolysis chamber 216, oximetry chamber 218, and reservoir 220 to enable the sample to successively flow therethrough, ultimately collecting in reservoir 220.

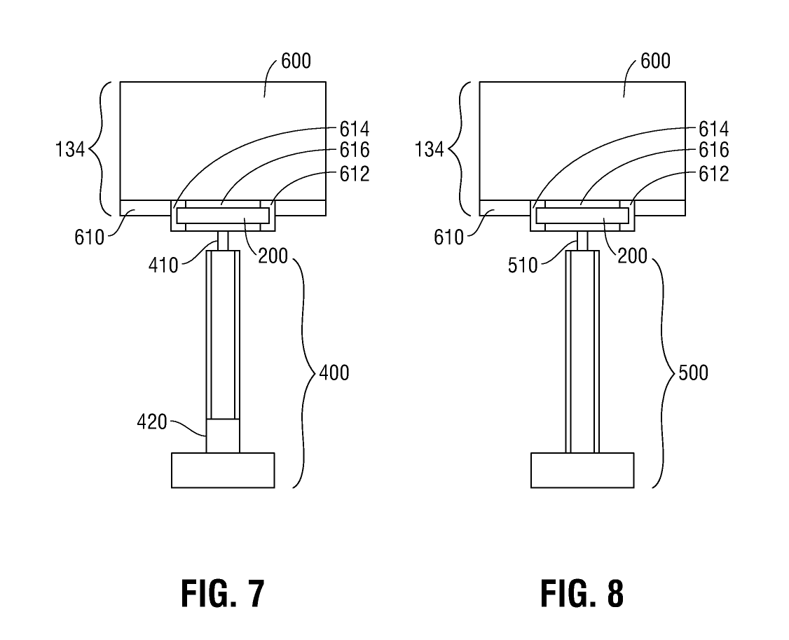

Ultrasonic hemolysis chamber 216 defines a generally disc-shaped configuration having an increased diameter and depth as compared to the adjacent interconnection portions 215b of main channel 214, although other configurations are also contemplated. As detailed below, a ultrasonic probe 410 (FIG. 7) of fixture block 132 of internal assembly 130 (FIG. 6) is configured to contact flexible membrane 230 adjacent ultrasonic hemolysis chamber 216 and apply ultrasonic energy to flexible membrane 230, which serves as a sonic coupler to transmit the vibration imparted to flexible membrane 230 from ultrasonic probe 410 (FIG. 7) to the sample, thereby causing the portion of the sample disposed within ultrasonic hemolysis chamber 216 to be disrupted, mixed, and/or hemolyzed. Ultrasonic hemolysis chamber 216 is positioned upstream of oximetry chamber 218 such that the sample is disrupted, mixed, and/or hemolyzed prior to entering oximetry chamber 218. Such has been found to produce more accurate oximetry readings by helping to reduce optical scatter and facilitating emulsification.

Referring additionally to FIG. 4B, oximetry chamber 218 is disposed between ultrasonic hemolysis chamber 216 and reservoir 220 and is connected thereto via respective interconnection portions 215b of main channel 214. Oximetry chamber 218 may define an increased width as compared to the adjacent interconnection portions 215b and defines an optical zone having a reduced depth “X₁” as compared to the surrounding portions of oximetry chamber 218 which define a depth “X₂.” The reduced depth ““X₁” may be established via a protrusion 219 that extends from plate 210 into oximetry chamber 218. As detailed below, this configuration of oximetry chamber 218 facilitates oximetry analysis of the sample flowing through the optical zone of oximetry chamber 218.

With reference again to FIG. 4A, reservoir 220 is disposed at an end of main channel 214 opposite sample socket 212 and defines an increased depth as compared to the adjacent interconnection portion 215b so as to collect the sample once it has flowed through the various portions of plate 210, e.g., linear body portion 215a of main channel 214, ultrasonic hemolysis chamber 216, and oximetry chamber 218. Further, as detailed below, reservoir 220 is disposed in communication with suction port 240 defined within flexible membrane 230 so as to permit the application of suction to main channel 214 and the various interconnected portions of plate 210 to aspirate the sample into main channel 214 and enable the sample to flow through linear body portion 215a of main channel 214, ultrasonic hemolysis chamber 216, oximetry chamber 218, and into reservoir 220.

Flexible membrane 230, as noted above, is adhered to plate 210 and encloses main channel 214, ultrasonic hemolysis chamber 216, oximetry chamber 218, and reservoir 220 of plate 210. Alternatively, a flexible membrane may only be disposed about ultrasonic hemolysis chamber 216, while plate 210 is enclosed via another suitable structure. Flexible membrane 230 further includes, as also noted above, plurality of sensors 236, cut-out 238, and suction port 240 defined therethrough, each of which will be detailed below. However, sensors 236 need not be positioned on membrane 230 but may be otherwise operably positioned on or coupled to plate 210. Similarly, suction port 240 may alternatively be defined through plate 210.

Sensors 236 are formed as 2 mm discs via punching and are pressed onto the pressure-sensitive adhesive layer 234 of flexible membrane 230. More specifically, sensors 236 are arranged linearly on the interior surface of flexible membrane 230 so as to be disposed within and aligned with linear body portion 215a of main channel 214 of plate 210, thus enabling the sample to flow over sensors 236. Sensors 236 are configured as fluorescent chemical sensors, e.g., optical electrodes or “optodes,” formed from specific chemical compounds and fluorescent dyes configured to react to analytes of interest in the sample. The fluorescence of sensors 236 can then be measured to ultimately enable the control electronics of analyzer 100 (FIGS. 1-3) to calculate the concentrations of the analyte(s) present in the sample based on the fluorescence measurements of sensors 236. In particular, one or more of sensors 236 may be configured to react to, and thereby enable detection and measurement of the concentrations of one or more constituents of blood gas, electrolytes, metabolites, etc. in the sample, such as, but not limited to pH, PO₂, PCO₂, Na⁺, K⁺, Ca⁺⁺, Cl⁻, lactate, creatinine, Mg⁺⁺, BUN, and glucose. Further, although sixteen sensors 236 are illustrated, it is envisioned that greater or fewer sensors 236 may be provided, depending upon a particular purposes. In other embodiments, sensors 236 are configured as ISE's which are configured to enable detection and measurement of the concentrations of one or more constituents of blood gas, electrolytes, metabolites, etc. Other suitable sensors for detecting and/or measuring analytes within a sample are also contemplated.

With additional reference again to FIG. 4B, the portion of pressure-sensitive adhesive layer 234 of flexible membrane 230 disposed about oximetry chamber 218 is removed, thus defining cut-out 238, which extends partially through flexible membrane 230 and is disposed over the optical zone of oximetry chamber 218. Pressure-sensitive adhesive layer 234 defines a thickness such that, together with the deep optical zone of oximetry chamber 218, defines an optical path length of between 50 μm and 110 μm that extends between protrusion 219 of plate 210 and PET film layer 232 of flexible membrane 230. The path length may more specifically be between 70 μm and 90 μm and, preferably, 80 μm. It is also contemplated that the thickness of cut-out 238 and/or the depth of oximetry chamber 218 be adjusted to maintain the desired optical path length, e.g., of 80 μm, or to achieve a different optical path length within or outside of the above-identified range. During manufacture, a laser gauge (not shown) may be utilized to accurately measure the optical path length of each cartridge 200 and such information may be stored with the calibration data for that particular cartridge 200, ultimately to be used by analyzer 100 (FIGS. 1-3) in calculating the oximetry readings based upon calibration data specific to the particular cartridge 200 under test. The analyzer 100 (FIGS. 1-3) can obtain such calibration data upon scanning barcode 260 of cartridge 200, similarly as detailed below with respect to barcode 1299 of cartridge 1200 and internal assembly 1020 (see FIGS. 10, 11, 13, 14, and 17).

Referring again to FIG. 4A, suction port 240 is defined through flexible membrane 230 adjacent reservoir 220 of plate 210. Suction port 240 may further include a hydrophobic membrane covering 242, or other covering or suitable structure, that permits a pump, e.g., syringe pump 1130 (FIG. 10), to apply suction to within main channel 214 of plate 210 to aspirate the sample into main channel 214 and initiate the flow of the sample therethrough, while also and preventing the escape of the sample through suction port 240. By preventing the escape of the sample through suction port 240, hydrophobic membrane covering 242 enables sanitary disposal of cartridge 200 after use. As noted above, sample socket 212 fluidly communicates with linear body portion 215a of main channel 214 and is configured to receive tube 213 that is adapted to connect the sampling device (not shown) to cartridge 200. As such, upon activation of a pump, e.g., syringe pump 1130 (FIG. 10), the sample is aspirated through tube 213 and sample socket 212 and into cartridge 200. More specifically, upon engagement of cartridge 200 within bay 142 of cartridge-receiving portion 140 of analyzer 100 (see FIGS. 1-3), suction port 240 is operably positioned to couple with the pump for creating suction at suction port 240, thereby aspirating the sample from the sampling device (not shown) into main channel 214 and initiating the flow of sample through cartridge 200.

Referring to FIGS. 4A, 5, and 6, as noted above, internal assembly 130 includes fixture block 132 and carrier assembly 134 and is configured to be mounted within housing 110 of analyzer 100 (FIG. 1). Fixture block 132 supports a plurality of detection apparatus. For example, four linearly arranged fluorometers 300 may be provided, although greater or fewer fluorometers are also contemplated, as are different detection apparatus such as, for example, ionmeters configured for use with ISE's. For the purposes herein, the use of fluorometers 300 is described; however, use of additional and/or different detection apparatus is also contemplated and fully within the scope of the present disclosure.

Each fluorometer 300 generally includes a light source, e.g., an LED 310, an excitation fiber 320, and an excitation filter 330 disposed between LED 310 and excitation fiber 320 that are arranged to direct fluorescent light towards the adjacent sensor 236 of cartridge 200. The electrons within the adjacent sensor 236, upon receiving the fluorescent light, are excited and, upon return to their at-test states, emit light of a different wavelength. Each fluorometer 300 further includes an emission fiber 340, a detector 350, and an emission filter 360 disposed between emission fiber 340 and detector 350 to enable the measurement of the intensity of the emitted light from the electrons of the adjacent sensor 236. The concentration of the particular analyte (for which the sensor 236 is configuration) may then be determined by calculating the difference between the measured fluorescence and that from a known calibration point.

Carrier assembly 134, as will be detailed below, is configured to convey cartridge 200 or fixture block 132 relative to the other, e.g., by moving cartridge along fixture block 132 or moving fixture block 132 along cartridge 200. More specifically, carrier assembly 134 is configured to convey cartridge 200 or fixture block 132 relative to the other from, for example, a first position, wherein the first, fifth, ninth, and thirteenth sensors 236 are positioned directly above and in alignment with the first, second, third, and fourth fluorometers 300, respectively, to enable measurement of the concentrations of analytes correspond to those sensors 236; a second position, wherein the second, sixth, tenth, and fourteenth sensors 236 are positioned directly above and in alignment with the first, second, third, and fourth fluorometers 300, respectively, to enable measurement of the concentrations of analytes correspond to those sensors 236; a third position, wherein the third, seventh, eleventh, and fifteenth sensors 236 are positioned directly above and in alignment with the first, second, third, and fourth fluorometers 300, respectively, to enable measurement of the concentrations of analytes correspond to those sensors 236; and a fourth position, wherein the fourth, eighth, twelfth, and sixteenth sensors 236 are positioned directly above and in alignment with the first, second, third, and fourth fluorometers 300, respectively, to enable measurement of the concentrations of analytes correspond to those sensors 236. Thus, each of the analytes corresponding to each of the sixteen sensors 236 can be detected and/or measured in only four iterations. As an alternative or in addition to conveying cartridge 200 or fixture block 132 relative to the other between various positions corresponding to different sensors 236, cartridge 200 may be moved between various different positions for positioning cartridge 200 adjacent different detection apparatus and/or other components of internal assembly 130, or those apparatus and/or components may be moved relative to cartridge 200 for the same purpose. For the purposes of simplicity, movement of cartridge 200 relative to fixture block 132 (and/or other apparatus/components) is detailed hereinbelow, keeping in mind that the various positions may equally be achieved by movement of fixture block 132 (and/or other apparatus/components) relative to cartridge 200.

Turning to FIGS. 4A, 5, and 7, in conjunction with FIG. 1, fixture block 132 additionally includes a hemolysis assembly 400 having an ultrasonic probe 410 coupled to an ultrasonic transducer 420. Ultrasonic probe 410 is configured for positioning in alignment with ultrasonic hemolysis chamber 216 of cartridge 200 in one of the first, second, third, or fourth positions of cartridge 200. Ultrasonic probe 410 may be configured to be advanced/retracted to move into contacting position with flexible membrane 230 of cartridge 200 adjacent ultrasonic hemolysis chamber 216 or may be retained in position such that, upon movement of cartridge 200 to the one of the first, second, third, or fourth positions in which ultrasonic probe 410 is properly aligned, ultrasonic probe 410 is disposed in contact with flexible membrane 230 adjacent ultrasonic hemolysis chamber 216. In use, when ultrasonic transducer 420 is activated, ultrasonic energy is transmitted along ultrasonic probe 410 and the vibration of such is imparted to flexible membrane 230 to vibrate flexible membrane 230, thereby causing the portion of the sample disposed within ultrasonic hemolysis chamber 216 to be disrupted, mixed, and/or hemolyzed.

With reference to FIGS. 4A, 4B, 5, and 8, fixture block 132 further includes an oximeter 500 (or other suitable spectrometer) including a fiber 510 that is configured for positioning in alignment with the optical zone defined within oximetry chamber 218 of cartridge 200 in one of the first, second, third, or fourth positions of cartridge 200. Fiber 510 is configured to pass light through the sample flowing through the optical zone defined within oximetry chamber 218, while an associated detector (not explicitly shown) is provided so as to measure the changing absorbance at each wavelength of light, thereby enabling oximetry measurements, e.g., of concentrations of MetHb, O₂Hb, RHb, tHb, COHb, etc. As noted above, the optical zone defines an optimal optical path length of 100 μm to facilitate accurate oximetry measurements.

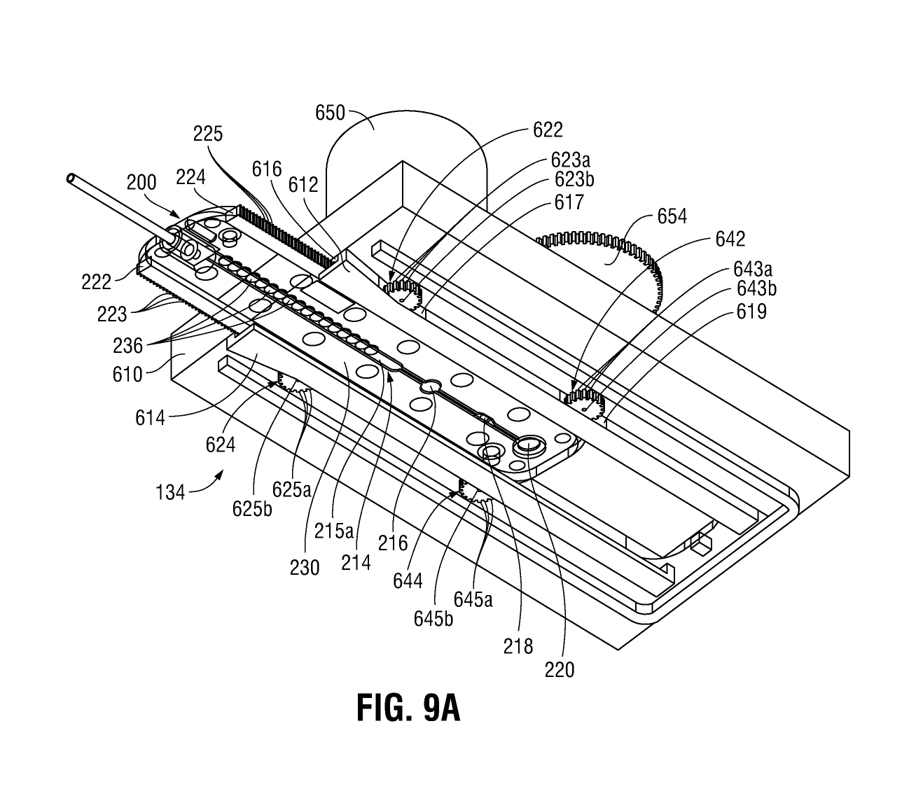

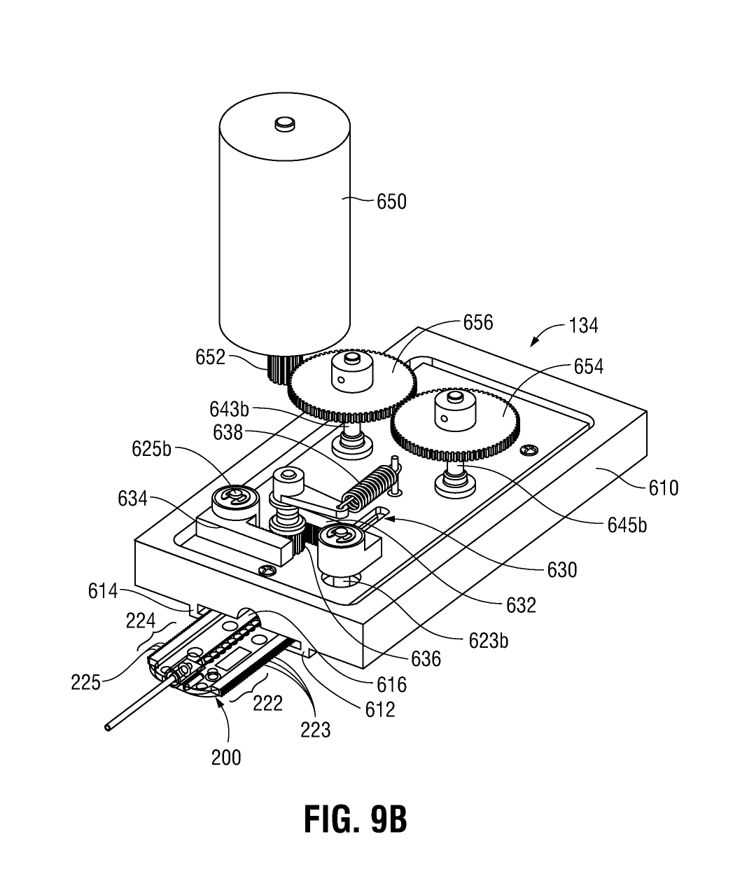

Referring to FIGS. 4A, 9A, and 9B, as mentioned above, carrier assembly 134 is configured to convey cartridge 200 along and relative to fixture block 132. More specifically, upon insertion of cartridge 200 into bay 142 of cartridge-receiving portion 140 of analyzer 100 (see FIG. 1), cartridge 200 is slid into operable engagement with carrier assembly 134 so as to enable carrier assembly 134 to translate cartridge 200 along and relative to fixture block 132 between the first, second, third, and fourth positions.

Plate 210 of cartridge 200, as noted above, defines first and second gear racks 222, 224, respectively, each including a plurality of gear teeth 223, 225, respectively extending along opposite longitudinal side edges of cartridge 200. Carrier assembly 134 includes a housing cover 600 (FIGS. 6-8; removed from FIGS. 9A and 9B to show the internal components of carrier assembly 134) that is disposed on a base 610 to enclose the internal components of carrier assembly 134. Base 610 includes a pair of spaced-apart guide brackets 612, 614 that define a slot 616 for slidable receipt of cartridge 200 therein. More specifically, brackets 612, 614 are configured to slidably receive and operably engage the longitudinal side edges of cartridge 200, while the rest of the underside of cartridge 200 remains exposed to enable a pump, e.g., syringe pump 1130 (FIG. 10), to operably couple with suction port 240, fluorometers 300 to measure the fluorescence of sensors 236, ultrasonic probe 410 to hemolyze the sample disposed within ultrasonic hemolysis chamber 216, and oximeter 500 to perform oximetry on the sample flowing through oximetry chamber 218. With longitudinal side edges of cartridge 200 received within brackets 612, 614, as can be appreciated, first and second gear racks 222, 224, are likewise disposed within respective brackets 612, 614.

Base 610 of carrier assembly 134 further includes a first pair of pinion gears 622, 624 disposed towards the open ends of brackets 612, 614, respectively. Each pinion gear 622, 624 defines a plurality of annularly-arranged teeth 623a, 625a and is supported on a rod 623b, 625b that extends through base 610 and is coupled to alignment mechanism 630 that is disposed on the topside of base 610. Pinion gears 622, 624 are rotatable relative to base 610 and are positioned to extend through slots 617 (only the slot 617 of bracket 612 is shown) defined within brackets 612, 614 to as to enable operable coupling of teeth 623a, 625a of pinions gears 622, 624 with teeth 223, 225 of gear racks 222, 224, respectively. As illustrated, pinion gears 622, 624 are idler pinions; that is, pinion gears 622, 624 are not actively driven but, rather, are rotated as cartridge 200 is translated through slot 616 and along base 610, and serve to guide translation of cartridge 200.

Rods 623b, 625b are provided with some degree of play relative to base 610 and are rotatably coupled to respective gear racks 632, 634 of alignment mechanism 630. Gear racks 632, 634, in turn, are coupled to a central gear 636 of alignment mechanism 630 on either side thereof. Central gear 636 is biased towards a “home” rotational orientation via spring 638. Thus, alignment mechanism 630 maintains the alignment of cartridge 200 and the synchronization of pinion gears 622, 624 as cartridge 200 is translated along base 610.

Base 610 of carrier assembly 134 further includes a second pair of pinion gears 642, 644 disposed towards the closed ends of brackets 612, 614, respectively. Similarly as with the first pair of pinion gears 622, 624, each of the second pinion gears 642, 644 defines a plurality of annularly-arranged teeth 643a, 645a and is supported on a rod 643b, 645b, respectively, that extends through base 610. Pinion gears 642, 644 are rotatable relative to base 610 and are positioned to extend through slots 619 (only the slot 619 of bracket 612 is shown) defined within brackets 612, 614 so as to enable operable coupling of teeth 643a, 645a of pinions gears 642, 644 with teeth 223, 225 of gear racks 222, 224, respectively.

Contrary to first pinion gears 622, 624 which are idler pinions, second pinion gears 642, 644 are driven pinions, although this configuration may be reversed or all of the pinion gears may be driven. In order to drive second pinion gears 642, 644, a drive motor 650 is provided. Drive motor 650 is coupled to a drive pinion 652 which, in turn is operably coupled to one of the meshed gears 654, 656 engaged about rods 643b, 645b, respectively, on the topside of base 610. Thus, upon activation of drive motor 650, drive pinion 652 is driven to rotate the one of the meshed gears, e.g., gear 656, which rotates rod 645b to rotate pinion gear 644. Since meshed gear 656 is disposed in meshed engagement with meshed gear 654, meshed gear 654 is also rotated, effecting rotation of rod 643b to thereby rotate pinion gear 642. As a result of this configuration, as can be appreciated, pinion gears 642, 644 are rotated in synchronization with one another. Further, due to the operable coupling of teeth 643a, 645a of pinions gears 642, 644 with teeth 223, 225 of gear racks 222, 224, respectively, when pinion gears 642, 644 are driven, cartridge 200 is urged to translate through slot 616 and relative to base 610.

Drive motor 650, as controlled via the control electronics (not shown), may be configured to incrementally translate cartridge 200 through brackets 612, 614 and relative to base 610 between four discrete positions, e.g., the first, second, third, and fourth positions, or may be configured to continuously translate cartridge 200 through the first, second, third, and fourth positions. Further, drive motor 650 may be configure to translate cartridge 200 from a zeroth position that is achieved upon slidable insertion of cartridge 200 into analyzer 100 (FIG. 1) to the four operable positions or, alternatively, the first position may correspond to the initial position of cartridge 200. The pump may be disposed in operable engagement with suction port 240 of cartridge 200 at the zeroth or initial position of cartridge 200 such that the sample is drawn into cartridge 200 initially, or cartridge 200 may be moved to a “filling” position between (or at either of) the zeroth/initial and first positions. The alignment of ultrasonic probe 410 and fiber 510 (see FIG. 5) may be achieved at any of the positions of cartridge 200, depending on a particular purpose.

Turning now to FIGS. 1-3 and 10-16B, another embodiment of an internal assembly 1020 configured for use with analyzer 100, and a disposable cartridge 1200 for use therewith to facilitate the detection and/or measurement of a plurality of analytes within a liquid sample, e.g., a blood sample, is provided in accordance with the present disclosure.

Referring to FIGS. 10, 11, 15A and 15B, internal assembly 1020 includes a support assembly 1060, a cartridge-retainer assembly 1080, control electronics (not shown), a fixture assembly 1120, a clamp assembly 1170, a hemolysis assembly 1100, a spectroscopy assembly 1110, a fluorometry assembly 1090, and a syringe pump 1130. Where not specifically contradicted herein, internal assembly 1020 may include any of the aspects and features of the OPTI LION™ Electrolyte Analyzer, noted above, and/or of internal assembly 130 (FIG. 6). Further, components detailed above with respect to internal assembly 130 (FIG. 6) that are common to internal assembly 1020 (FIG. 10) may include similar features and be configured similarly, except where specifically noted below.

Support assembly 1060 includes a main board 1062 and a support plate 1064. Main board 1062 supports the control electronics (not shown) of internal assembly 1020, supports fixture assembly 1120 on an upper side thereof, and supports clamp assembly 1170, hemolysis assembly 1100, and spectroscopy assembly 1110 on the underside thereof. Support plate 1064 supports syringe pump 1130 and is operably coupled to clamp assembly 1170 via a pair of posts 1066, with main board 1062 coupled to support plate 1064 and disposed between support plate 1064 and clamp assembly 1170. Clamp assembly 1170 includes a motor 1172 and a frame 1174 operably coupled to motor 1172. Frame 1174 includes the posts 1066 engaged thereto at either end thereof and is movable, in response to actuation of motor 1172, to thereby move support assembly 1060, e.g., support plate 1064 and main board 1062, relative to cartridge-retainer assembly 1080. Such movement of support assembly 1060, which includes fixture assembly 1120 engaged atop main board 1062, thus moves fixture assembly 1120 relative to cartridge-retainer assembly 1080 to enable clamping of cartridge 1200 between fixture assembly 1120 and base 1082 of cartridge-retainer assembly 1080. As can be appreciated, clamping cartridge 1200 in this manner helps ensure that cartridge 1200 is retained in position relative to the operable components of internal assembly 1020 (FIG. 10), e.g., hemolysis assembly 1100, spectroscopy assembly 1110, fluorometry assembly 1090, and syringe pump 1130.

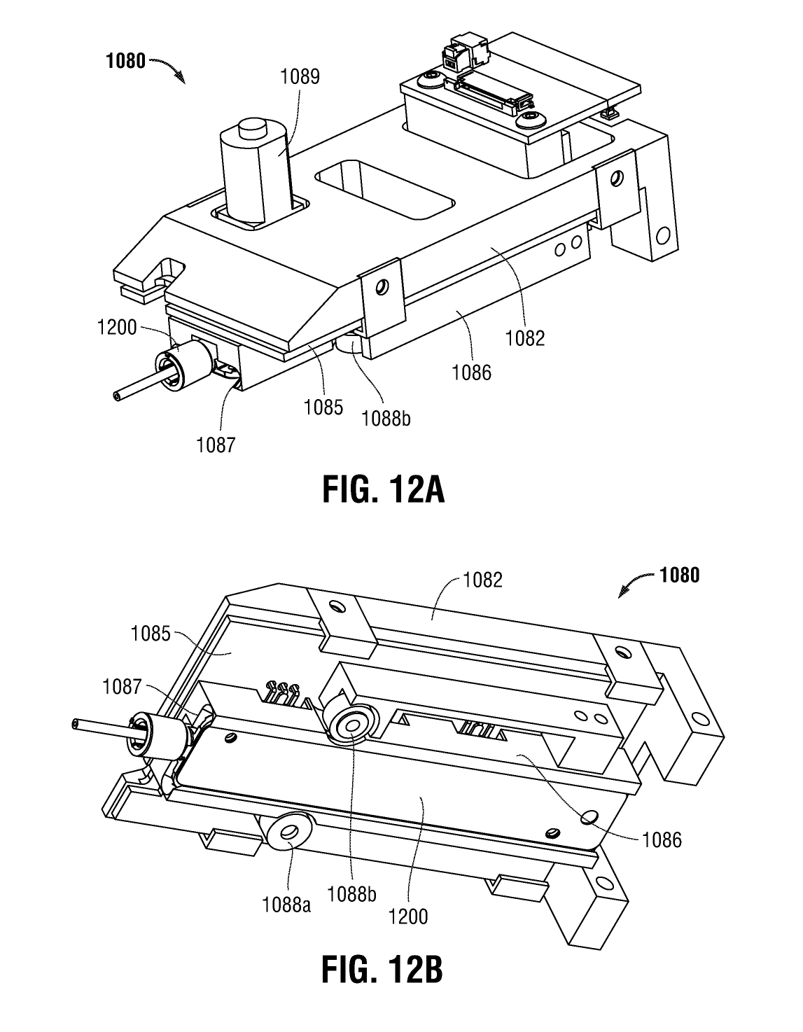

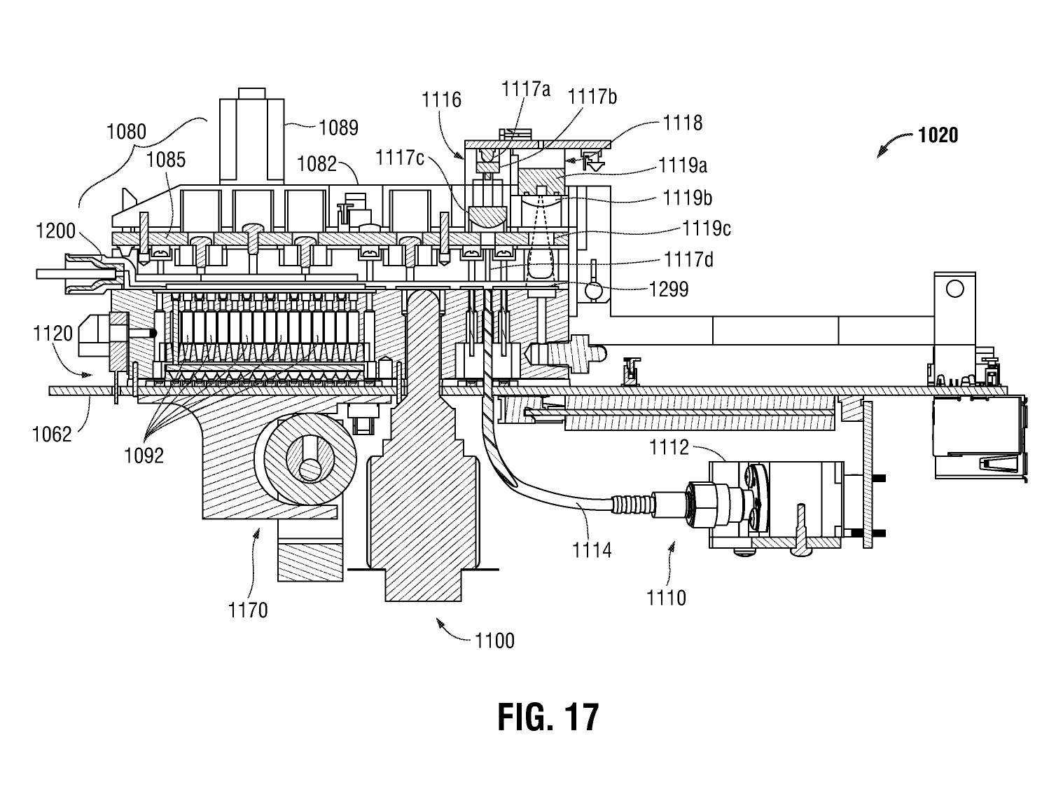

With additional reference to FIGS. 12A and 12B, cartridge-retainer assembly 1080 includes a base 1082 having a heater assembly 1085 coupled thereto, and a cartridge track member 1086 disposed on an underside thereof. Heater assembly 1085 is configured to maintain cartridge 1200 at a specific temperature set point during use. Cartridge guide or track member 1086 defines a track 1087 configured to receive cartridge 1200 upon insertion of cartridge 1200 through bay 142 of cartridge-receiving portion 140 of analyzer 100 (see FIG. 1). Cartridge track member 1086 further includes a carrier assembly having first and second rollers 1088a, 1088b disposed on either side of track 1087 and extending at least partially into track 1087 so as to contact the outer frictional edges or surfaces of cartridge 1200. Rollers 1088a, 1088b are configured to guide cartridge 1200 into position within cartridge track member 1086 via frictional engagement therewith. In embodiments, one of the rollers, e.g., roller 1088a, is driven by a motor 1089 so as to automatically feed cartridge 1200 into position within cartridge track member 1086. The other roller, e.g., roller 1088b, is an idler roller that serves to frictionally engage and guide translation of cartridge into cartridge track member 1086, although both rollers 1088a, 1088b may alternatively be driven rollers. As an alternative to friction rollers, a rack and pinion or other suitable drive mechanism may be utilized for moving cartridge 200 into position, e.g., the rack and pinion configuration detailed above. Likewise, as an alternative to the rack and pinion configuration of internal assembly 130 (FIGS. 5-9B) and cartridge 200 (FIGS. 4A and 4B), a friction roller configuration similar to that detailed above may be utilized for moving cartridge 200 relative to analyzer 100. Cartridge-retainer assembly 1080 further houses, within base 1082, an oximetry light source assembly 1116 and a camera assembly 1118 (see FIG. 17), as will be detailed below with respect to FIG. 17.

Turning to FIGS. 13 and 14, cartridge 1200 is similar to cartridge 200 (FIG. 4A) and, thus, only the differences therebetween will be detailed below, while similarities will be summarily described or omitted entirely. Cartridge 1200 includes a plate 1210 and a flexible membrane 1220 sealed to plate 1210. Plate 1210 defines a sample socket 1212, a main channel 1214, an ultrasonic hemolysis chamber 1216, an oximetry chamber 1218, and a reservoir 1222. Flexible membrane 1220 includes a plurality of sensors 1236, e.g., 16 sensors, operably positioned relative to a linear body portion 1215a of main channel 1214. Linear body portion 1215a of main channel 1214 is disposed in fluid communication with sample socket 1212 while interconnection portions 1215b of main channel 1214 serve to fluidly interconnect linear body portion 1215a, ultrasonic hemolysis chamber 1216, oximetry chamber 1218, and reservoir 1222. Flexible membrane 1220 further defines a suction port 1223 therethrough adjacent reservoir 1222. A hydrophobic membrane covering 1224 is disposed about suction port 1223, similarly as detailed above with respect to cartridge 200 (FIG. 4A). Cartridge 1200 further includes one or more barcodes 1299 disposed thereon, similarly as detailed above with respect to barcode 260 of cartridge 200 (FIG. 4A) except that the location of one or more of barcodes 1299 may be different.

As illustrated in FIG. 13, a first jog 1270 interrupts the interconnection portion 1215b of main channel 1214 disposed between linear body portion 1215a and ultrasonic hemolysis chamber 1216. First jog 1270 defines a plurality of segments joined at right angles relative to one another and the segments of interconnection portion 1215b on either side thereof, e.g., first jog 1270 defines a half-square-wave configuration, although other configurations are also contemplated. First jog 1270 inhibits the transmission of ultrasonic energy from ultrasonic hemolysis chamber 1216 upstream towards linear body portion 1215a of main channel 1214. The sonic filter or sonic interruption provided by first jog 1270 inhibits lysing of the cells in the sample upstream of ultrasonic hemolysis chamber 1216 resulting from the upstream transmission of ultrasonic energy. It has been found that lysing of cells can result in inaccurate readings produced from sensors 1236 and fluorometry assembly 1090, e.g., a spike in potassium readings has been found to occur when measuring the fluorescence of lysed cells.

As illustrated in FIG. 14, in embodiments, a second jog 1280 may additionally or alternatively be provided to interrupt the interconnection portion 1215b of main channel 1214 disposed between ultrasonic hemolysis chamber 1216 and oximetry chamber 1218. Second jog 1280 may be configured similarly as first jog 1270 or may define any other suitable configuration. The sonic filter or sonic interruption provided by second jog 1280 inhibits inaccurate readings from spectroscopy assembly 1110 as a result of bubbling, frothing, or other turbulence resulting from the downstream transmission of ultrasonic energy from ultrasonic hemolysis chamber 1216.

Continuing with reference to FIGS. 13 and 14, cartridge 1200 further includes a plurality of alignment apertures 1290, e.g., first and second alignment apertures 1290 positioned on opposite sides and adjacent opposite ends of cartridge 1200, although other configurations are also contemplated. The importance of alignment apertures will be detailed below.

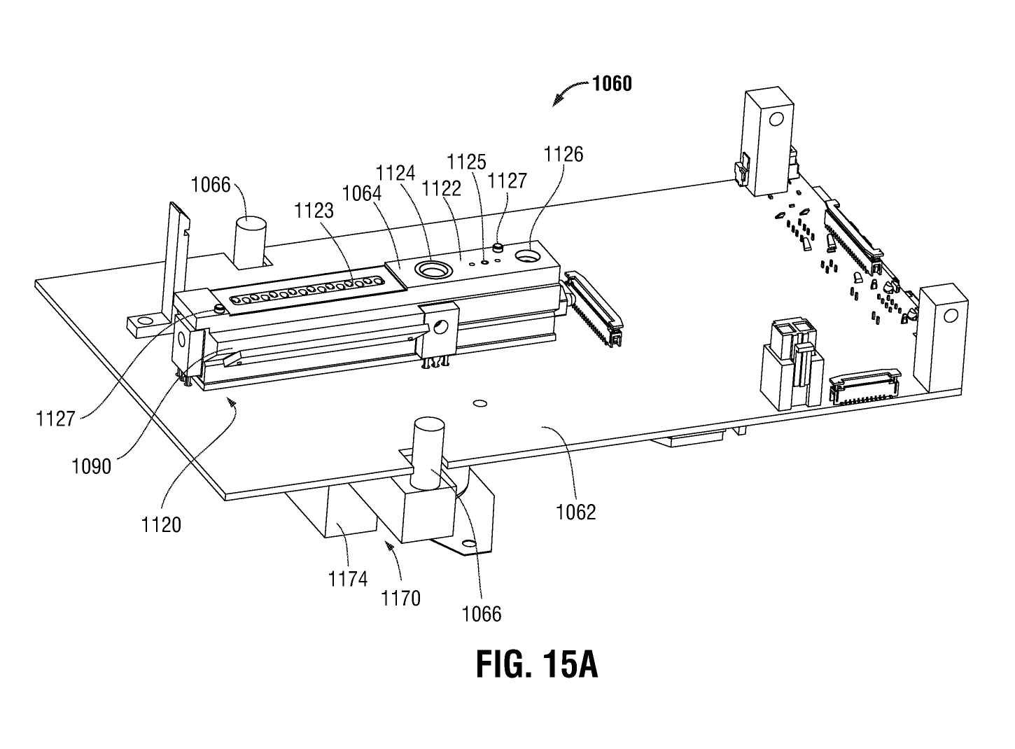

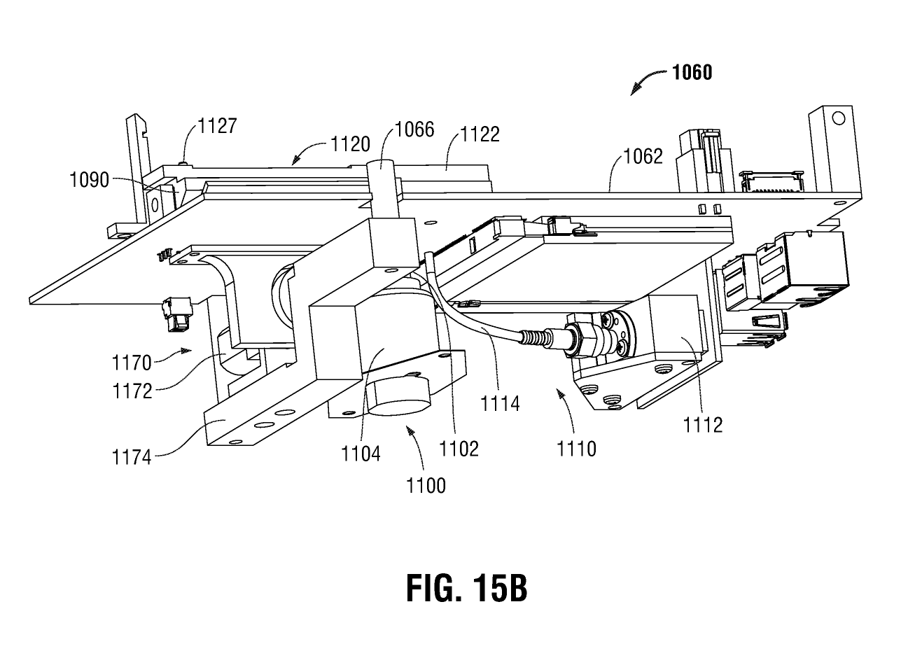

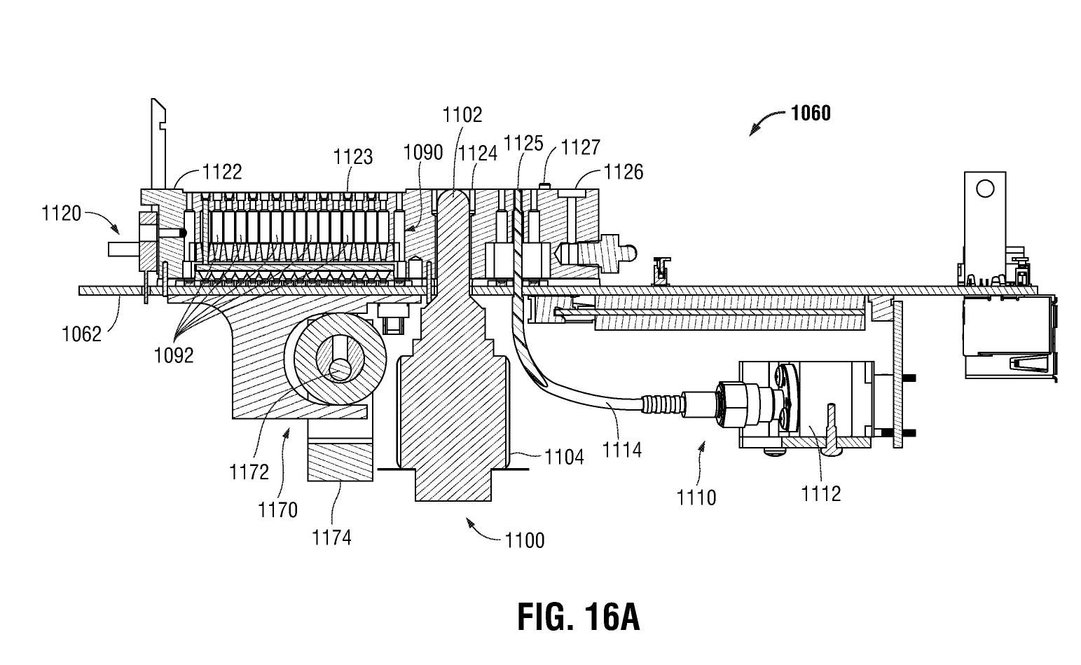

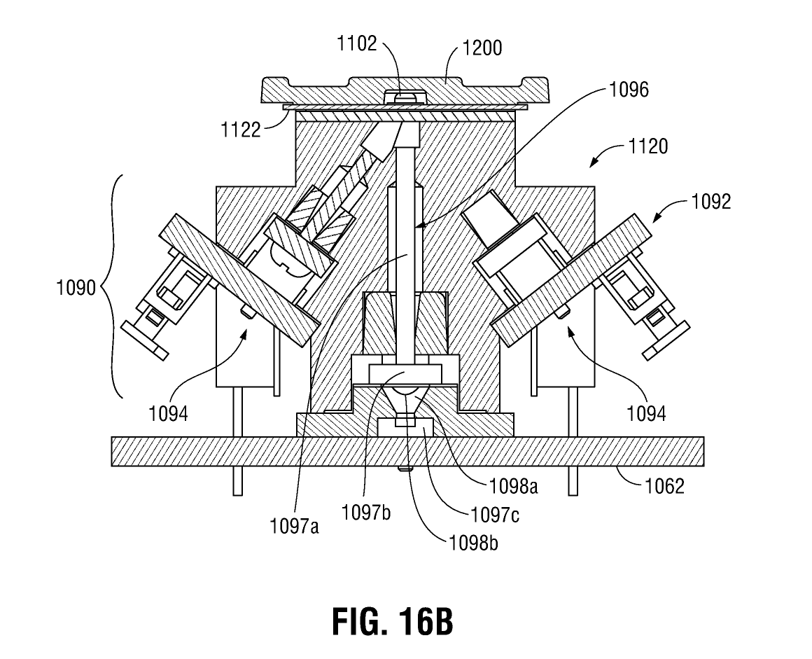

Referring to FIGS. 15A-16B, fluorometry assembly 1090 includes a plurality of linearly arranged fluorometers 1092 corresponding to the number of sensors 1236 of cartridge 1200, although greater or fewer fluorometers are also contemplated, as are different detection apparatus such as, for example, ionmeters configured for use with ISE's. The fluorometers are similar to fluorometers 300 (FIG. 5) detailed above and are configured to direct fluorescent light towards an adjacent sensor 1236 of cartridge 1200 and measure the intensity of the emitted light from the adjacent sensor 1236 (see FIG. 13). More specifically, each fluorometer 1092 includes an excitation assembly 1094 and detection assembly 1096. The excitation assembly 1094 includes an LED or other suitable light source, an excitation fiber, and an excitation filter, similarly as detailed above with respect to internal assembly 130 (FIGS. 5-9B). The detection assembly 1096, as also detailed above with respect to internal assembly 130 (FIGS. 5-9B), includes an emission fiber 1097a, an emission filter 1097b, and a detector 1097c. The excitation assemblies 1094 are larger in size as compared to the detection assemblies 1096 due at least in part to the size of the light source, e.g., the LEDs. As a result, and in order to reduce the overall size and provide a more compact fluorometry assembly 1090, the excitation assemblies 1094 are alternatingly positioned on opposite sides of the corresponding detection assemblies 1096, defining a “cross-fire” type arrangement. This feature is best illustrated in FIG. 16B and within window 1123 in FIG. 15A.

As best illustrated in FIG. 16B, and as noted above, the detection assembly 1096 of each fluorometer 1092 includes emission fiber 1097a, emission filter 1097b, and detector 1097c. More specifically, the detection assembly 1096 of each fluorometer 1092 is configured with the emission fiber 1097a extending from directly beneath the platform 1122 downwardly to the corresponding emission filter 1097b, and with the corresponding detector 1097c positioned on the opposite side of the emission filter 1097b. A detector slab 1098a is disposed between each of the detectors 1097c and the corresponding emission filter 1097b. The detector slab 1098a defines a plurality of apertures 1098b wherein each aperture corresponds to one of the detection assemblies 1096. The apertures 1098b define conical-shaped configurations. The conical-shaped configurations of the apertures 1098b mask rays of light coming through the emission filters 1097b that are not substantially perpendicular to the filters 1097b. Such is important in that the emission filters 1097b perform adequate filtering only on perpendicular rays. Thus, without the apertures 1098b, a larger portion of angular rays (poorly filtered light) would reach the detectors 1097c, potentially introducing error into the measurement. Further, conical apertures 1098b are advantageous over cylindrical apertures in that the conical apertures 1098b help to eliminate reflections of angled light which would otherwise reflect off the inner side of a cylindrical aperture and continue to the detector 1097c. Reflections from conical apertures 1098b, in contrast, are reflected up and away from the corresponding detector 1097c such that the poorly filtered light is not captured.

Referring again to FIGS. 15A-16B, hemolysis assembly 1100 includes an ultrasonic probe 1102 coupled to an ultrasonic transducer 1104. Ultrasonic probe 1102 is configured to contact flexible membrane 1220 of cartridge 1200 adjacent hemolysis chamber 1216 (see FIG. 13) and impart ultrasonic energy thereto to vibrate flexible membrane 1220 and disrupt, mix, and/or hemolyze the portion of the sample disposed within hemolysis chamber 1216 (see FIG. 13).

Spectroscopy assembly 1110 includes a spectrometer 1112, e.g., an oximeter or other suitable spectrometer, and a fiber optic cable 1114 that is configured for positioning in alignment with the optical zone defined within oximetry chamber 1218 of cartridge 1200 (see FIG. 13). Fiber optic cable 1114 is configured to receive the light that has been emitted from oximetry light source assembly 1116 (FIG. 17) and passed through the sample flowing through the optical zone defined within oximetry chamber 1218 (FIG. 13). Fiber optic cable 1114 transmits this light to spectrometer 1112 to enable spectrometer 1112 to measure the changing absorbance at each wavelength of light, thereby enabling oximetry measurements.

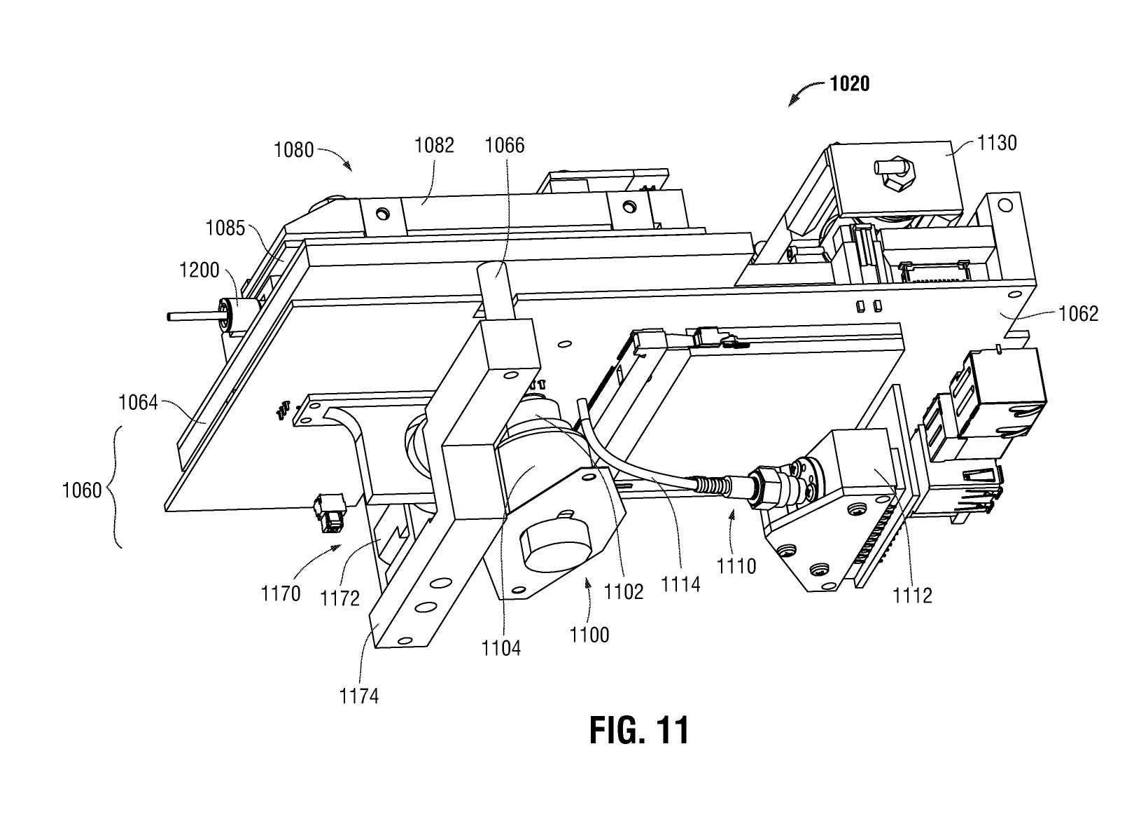

With additional reference to FIGS. 11A, 11B, and 13, fixture assembly 1120, as mentioned above, is supported on main board 1062. Fixture assembly 1120 includes a platform 1122 disposed atop fluorometry assembly 1090 and operably coupled with hemolysis assembly 1100, spectroscopy assembly 1110, and syringe pump 1130. More specifically, platform 1122 defines a window 1123 so as to enable each fluorometer 1092 to interface with the corresponding sensor 1236 of cartridge 1200, a first aperture 1124 configured to permit ultrasonic probe 1102 of hemolysis assembly 1100 to extend through platform 1122 and contact flexible membrane 1220 adjacent hemolysis chamber 1216, a second aperture 1125 configured to permit fiber optic cable 1114 of spectroscopy assembly 1110 to be operably positioned adjacent oximetry chamber 1218 of cartridge 1200, and a port 1126 that enables coupling of reservoir 1222 of cartridge 1200 with syringe pump 1130.

Platform 1122 of fixture assembly 1120 further includes a plurality of alignment pegs 1127 each corresponding to a respective alignment aperture 1290 of cartridge 1200, e.g., first and second alignment pegs positioned on opposite sides and adjacent opposite ends of platform 1122, although other configurations are also contemplated. As can be appreciated, pegs 1127 are configured for receipt within apertures 1290 defined within cartridge 1200 to align cartridge 1200 relative to platform 1122 of fixture assembly 1120. More specifically, pegs 1127 and apertures 1290 are positioned such that, upon engagement thereof, sensors 1236 of cartridge 1200 are properly positioned relative to the respective fluorometers 1092 of fluorometry assembly 1090, hemolysis chamber 1218 of cartridge 1200 is aligned with ultrasonic probe 1102 of hemolysis assembly 1100, oximetry chamber 1218 of cartridge 1200 is aligned with fiber optic cable 1114 of spectroscopy assembly 1110, and reservoir 1222 is aligned with port 1126 of platform 1122.

Turning to FIG. 17, cartridge 1200 is shown clamped between fixture assembly 1120 and cartridge-retainer assembly 1080. As noted above, the operable components of fixture assembly 1120 are properly positioned relative to the corresponding components of cartridge 1200. Further, in addition to fiber optic cable 1114 of spectroscopy assembly 1110 being aligned with oximetry chamber 1218 (FIGS. 13 and 14) of cartridge 1200, as noted above, oximetry light source assembly 1116 is aligned with oximetry chamber 1218 (FIGS. 13 and 14) of cartridge 1200 opposite fiber optic cable 1114 so as to direct light through oximetry chamber 1218 (FIGS. 13 and 14) of cartridge 1200, thus facilitating oximetry measurements of the sample disposed therein. Oximetry light source assembly 1116, more specifically, includes, a white LED 1117a, a diffuser 1117b, a lens 1117c, and a transmission optic fiber 117d stacked above oximetry chamber 1218 (FIGS. 13 and 14) of cartridge 1200 opposite fiber optic cable 1114. White LED 1117a emits a beam of white light, which, upon passing through diffuser 1117b, is expanded to fill the input aperture of lens 1117c. The lens 1117c directs the light to transmission optic fiber 1117d, which transmits the light to and through oximetry chamber 1218 (FIGS. 13 and 14) of cartridge 1200. Upon passing through cartridge 1200, a portion of the light is detected by fiber optic cable 1114 and transmitted to spectrometer 1112 whereby, based upon the changing absorbance at each wavelength of light, oximetry can be performed.

Camera assembly 1118 is positioned to align with barcode 1299 of cartridge 1200 for enabling the reading of the calibration parameters of the particular cartridge 1200. More specifically, in the fully inserted position of cartridge 1200, barcode 1299 of cartridge 1200 is positioned within the viewing envelope of camera assembly 1118 to enable camera assembly 1118 to read identifying information and/or calibration parameters for that particular cartridge 1200. Camera assembly 1118 includes a video camera 1119a, a lens 1119b, and an illumination source 1119c, e.g., one or more LEDs, to enable such reading of barcode 1299.

Referring generally to FIGS. 1-3 and 10-17, in use, cartridge 1200 is initially inserted into cartridge-receiving portion 140 of analyzer 100 sufficiently such that cartridge 1200 is at least partially positioned between rollers 1088a, 1088b of cartridge-retainer assembly 1080. Once this position has been achieved, motor 1089 is activated to drive roller 1088a to automatically feed cartridge 1200 further into track 1087 of cartridge track member 1086 to its operable position within cartridge-retainer assembly 1080. Once this position has been achieved, motor 1172 of clamp assembly 1170 is activated to move support assembly 1060 towards cartridge-retainer assembly 1080 ultimately such that cartridge 1200 is clamped therebetween with pegs 1127 of platform 1122 of fixture assembly 1120 received within alignment apertures 1290 of cartridge 1200. This clamping of cartridge 1200 inhibits warping of cartridge 1200 during use, while the engagement of pegs 1127 within alignment apertures 1290 maintains cartridge 1200 in proper alignment with fixture assembly 1120. In this clamped and aligned position, a sample may be aspirated into cartridge for performing fluorometry and/or spectroscopy testing, similarly as detailed above with respect to internal assembly 130 (FIGS. 5-9B) except that translation of cartridge 1200 is not required.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A cartridge configured to receive a blood sample to be analyzed, comprising:
a plate defining, on a face surface thereof, a main channel, a hemolysis chamber disposed in fluid communication with the main channel and configured to facilitate hemolysis of sample disposed within the hemolysis chamber, an oximetry chamber configured to facilitate oximetry of sample disposed within the oximetry chamber, and an interconnection channel coupling the hemolysis chamber and oximetry chamber to one another in fluid communication so as to define a sample flow path from the main channel through the hemolysis chamber and the oximetry chamber.

2. The cartridge according to claim 1, further including a plurality of sensors operably positioned adjacent to and aligned with the main channel defined within the plate.

3. The cartridge according to claim 2, wherein the sensors are chemical fluorescence sensors or ion selective electrodes.

4. The cartridge according to claim 1, further including a flexible membrane, at least a portion of the flexible membrane disposed adjacent the hemolysis chamber and configured to transmit ultrasonic energy to sample disposed within the hemolysis chamber.

5. The cartridge according to claim 1, wherein a flexible membrane is disposed about and sealed to the face surface of the plate, the flexible membrane formed from an outer film layer and an inner adhesive layer configured to adhere the flexible membrane to the face surface of the plate.

6. The cartridge according to claim 5, wherein the plate defines a protrusion that protrudes into the oximetry chamber.

7. The cartridge according to claim 6, wherein the protrusion is positioned to define an optical path length between an opposed surface of the protrusion of the plate and an opposed surface of the flexible membrane.

8. The cartridge according to claim 1, further including a suction port and wherein another interconnection channel couples the oximetry chamber and the suction port to one another in fluid communication.

9. The cartridge according to claim 8, wherein the cartridge further includes a socket configured to couple to a sample source and wherein the suction port is configured to couple to a pump for aspirating sample from the sample source into the main channel and for initiating the flow of sample along the sample flow path.

10. The cartridge according to claim 1, wherein the plate further includes a carrier element disposed along each longitudinal side edge thereof, the carrier elements configured to operably engage a carrier assembly to translate the cartridge relative to an analyzer configured to receive the cartridge.

11. The cartridge according to claim 10, wherein the carrier elements are gear racks extending longitudinally along the longitudinal side edges of the plate, each gear rack defining a plurality of teeth.

12. The cartridge according to claim 10, wherein the carrier elements are friction surfaces extending longitudinally along the longitudinal side edges of the plate.

13. The cartridge according to claim 1, wherein the plate further defines at least one alignment aperture extending therethrough.

14. The cartridge according to claim 1, further including a first jog defined within the plate and positioned between the main channel and the hemolysis chamber in fluid communication therewith, the first jog configured to inhibit the transmission of energy along the sample flow path upstream from the hemolysis chamber.

15. The cartridge according to claim 1, further including a second jog defined within the interconnection channel of the plate and positioned between the hemolysis chamber and the oximetry chamber in fluid communication therewith, the second jog configured to inhibit the transmission of energy along the sample flow path downstream from the hemolysis chamber.

16. A system for testing a sample, comprising:
an analyzer including at least one detection apparatus, a hemolyzer, and an oximeter; and
a cartridge configured for operable engagement with the analyzer, the cartridge including:
a main channel;
a plurality of sensors disposed adjacent the main channel, the sensors configured to facilitate detection via the at least one detection apparatus;
a hemolysis chamber disposed in fluid communication with the main channel, the hemolyzer configured to hemolyze sample disposed within the hemolysis chamber; and
an oximetry chamber disposed in fluid communication with the hemolysis chamber, the oximetry chamber configured to facilitate oximetry of sample disposed within the oximetry chamber via the oximeter,
wherein a sample flow path is defined from the main channel through the hemolysis chamber and the oximetry chamber for flow of sample therethrough.

17. The system according to claim 16, wherein the at least one detection apparatus includes at least one fluorometer for enabling fluorescence detection of at least one of the sensors.

18. The system according to claim 16, wherein the analyzer further includes a carrier assembly configured to move the cartridge between at least two positions.

19. The system according to claim 18,
wherein the cartridge further includes a gear rack disposed along each longitudinal side edge thereof, and
wherein the carrier assembly further includes:
a guide configured to slidably receive at least a portion of the cartridge;
at least one driven pinion gear disposed adjacent the guide, the at least one driven pinion gear configured to operably engage one of the gear racks of the cartridge such that, upon rotational driving of the at least one driven pinion gear, the cartridge is translated relative to the guide; and
a motor coupled to the at least one driven pinion gear for driving the at least one driven pinion gear.

20. The system according to claim 19, wherein the carrier assembly further includes at least one idler pinion gear configured to operably engage one of the gear racks of the cartridge to guide translation of the cartridge relative to the guide.

21. The system according to claim 18,
wherein the cartridge further includes a friction surface extending along each longitudinal side edge thereof, and
wherein the carrier assembly further includes:
a guide configured to slidably receive at least a portion of the cartridge;
a driven roller disposed adjacent a side of the guide, the drive roller configured to frictionally engage one of the friction surfaces of the cartridge such that, upon rotational driving of the driven roller, the cartridge is translated relative to the guide; and
a motor coupled to the driven roller for driving the driven roller.

22. The system according to claim 21, wherein the carrier assembly further includes an idler roller configured to frictionally engage the other of the frictional surfaces of the cartridge to guide translation of the cartridge relative to the guide.

23. The system according to claim 18, wherein the carrier assembly is configured to automatically feed the cartridge into a testing position within the analyzer.

24. The system according to claim 18, wherein the carrier assembly is configured to translate the cartridge between different testing positions within the analyzer.

25. The system according to claim 16, wherein the hemolyzer includes an ultrasonic probe, the ultrasonic probe configured to contact a portion of the cartridge adjacent the hemolysis chamber to transmit ultrasonic energy to sample disposed within the hemolysis chamber.

26. The system according to claim 16, wherein the oximetry chamber defines an optical path length of between 50 μm and 110 μm to facilitate oximetry of sample disposed within the oximetry chamber via the oximeter.

27. The system according to claim 16,
wherein the cartridge further includes a suction port and a socket configured to couple to a sample source, and
wherein the analyzer further includes a pump configured to couple to the suction port for aspirating sample from the sample source into the cartridge and for initiating the flow of sample along the sample flow path.

28. The system according to claim 16, wherein the analyzer further includes a cartridge-retainer assembly configured to operably retain the cartridge therein.

29. The system according to claim 28, wherein the analyzer further includes a support assembly that supports the at least one detection apparatus, the hemolyzer, and the oximeter.

30. The system according to claim 29, wherein the analyzer further includes a clamp assembly configured to move the support assembly relative to the cartridge-retainer assembly to clamp the cartridge therebetween.

31. The system according to claim 16, wherein the analyzer further includes a heater configured to heat the cartridge to a pre-determined temperature.

32. The system according to claim 16, wherein the cartridge defines at least one alignment aperture and wherein the analyzer includes at least one peg, the at least one peg configured for receipt within the at least one alignment aperture to align the cartridge relative to the analyzer.

33. An analyzer for testing a sample, comprising:
a detection block including a plurality of chemical detection apparatus;
a hemolyzer;
an oximeter; and
a cartridge-receiving portion configured to receive and operably position a single-use cartridge relative to the detection block, hemolyzer, and oximeter.

34. The analyzer according to claim 33, wherein each chemical detection apparatus includes a fluorometer having an emission assembly and a detection assembly.

35. The analyzer according to claim 34, wherein the emission assemblies of adjacent fluorometers are positioned on opposite sides of the corresponding detection assemblies thereof.

36. The analyzer according to claim 34, wherein the detection assembly of each fluorometer includes an emission fiber, an emission filter, and a detector, and wherein a conical-shaped aperture is defined between the emission filter and the detector of each detection assembly to inhibit rays of light that are non-perpendicular relative to the emission filter from reaching the detector.

37. The analyzer according to claim 33, wherein at least one of the chemical detection apparatus includes a voltmeter configured for measuring a voltage from an ion-specific electrode sensor.

38. The analyzer according to claim 33, wherein the cartridge-receiving portion includes a carrier assembly having:
a guide configured to slidably receive at least a portion of the single-use cartridge;
at least one driven pinion gear disposed adjacent the guide, the at least one driven pinion gear configured to operably engage the single-use cartridge such that, upon rotational driving of the at least one driven pinion gear, the single-use cartridge is translated relative to the guide; and
a motor coupled to the at least one driven pinion gear for driving the at least one driven pinion gear.

39. The analyzer according to claim 38, wherein the carrier assembly further includes at least one idler pinion gear configured to operably engage the single-use cartridge to guide translation of the single-use cartridge relative to the guide.

40. The analyzer according to claim 33, wherein the cartridge-receiving portion includes a carrier assembly having:
a guide configured to slidably receive at least a portion of the single-use cartridge;
a driven roller disposed adjacent a side of the guide, the drive roller configured to frictionally engage the single-use cartridge such that, upon rotational driving of the driven roller, the single-use cartridge is translated relative to the guide; and
a motor coupled to the driven roller for driving the driven roller.

41. The analyzer according to claim 40, wherein the carrier assembly further includes an idler roller configured to frictionally engage the single-use cartridge to guide translation of the single-use cartridge relative to the guide.

42. The analyzer according to claim 33, wherein the cartridge-receiving portion is configured to automatically feed the single-use cartridge into a testing position within the analyzer.

43. The analyzer according to claim 33, wherein the cartridge-receiving portion is configured to translate the single-use cartridge between different testing positions within the analyzer.

44. The analyzer according to claim 33, wherein the hemolyzer includes an ultrasonic probe, the ultrasonic probe configured to contact a portion of the single-use cartridge to transmit ultrasonic energy thereto.

45. The analyzer tem according to claim 33, further including a pump configured to facilitate aspirating sample into the single-use cartridge.

46. The analyzer according to claim 33, further including a support assembly that supports the plurality of chemical detection apparatus, the hemolyzer, and the oximeter.

47. The analyzer according to claim 46, further including a clamp assembly configured to move the support assembly relative to the cartridge-retainer assembly to clamp the single-use cartridge therebetween.

48. The analyzer according to claim 33, further including a heater configured to heat the single-use cartridge to a pre-determined temperature.

49. The analyzer according to claim 33, wherein the analyzer is further configured to facilitate introduction of a sample into the single-use cartridge once the single-use cartridge is received and operably positioned relative to the detection block, hemolyzer, and oximeter.
